(19) United States
(12) Patent Application Publication
(10) Pub. No.: US 2021/0094885 A1
(43) Pub. Date: Apr. 1, 2021

(54) REDUCED ANISOTROPY ALUMINUM TITANATE-CORDIERITE CERAMIC BODIES, BATCH MIXTURES INCLUDING SPHERICAL ALUMINA, AND METHODS OF MANUFACTURING CERAMIC BODIES THEREFROM

(71) Applicant: CORNING INCORPORATED, Corning, NY (US)

(72) Inventor: Monika Backhaus-Ricoult, Bourron (FR)

(21) Appl. No.: 17/036,784

(22) Filed: Sep. 29, 2020

Related U.S. Application Data
(60) Provisional application No. 62/908,154, filed on Sep. 30, 2019.

(51) Int. Cl. C04B 38/00; C04B 38/06; C04B 35/478; C04B 35/64

(52) U.S. Cl. CPC C04B 38/0006; C04B 38/0054; C04B 38/0635; C04B 35/478; C04B 35/64; C04B 2235/3234; B28B 3/20; C04B 2235/3418; C04B 2235/528; C04B 2235/6021; C04B 2235/76; C04B 2235/9607; C04B 2235/3222

(57) ABSTRACT

A ceramic honeycomb body exhibiting a primary phase of aluminum titanate solid solution with a pseudobrookite structure, and a secondary phase of cordierite. The ceramic honeycomb body contains the aluminum titanate solid solution in an amount greater than or equal to 50 wt. % and cordierite in an amount greater than or equal to 20 wt. %. Low anisotropy is demonstrated by the primary phase of aluminum titanate solid solution by comprising an AT tangential/axial i-ratio≤1.35. Batch mixtures including spherical alumina and methods of manufacturing ceramic honeycomb bodies using the batch mixtures with spherical alumina are provided, as are other aspects.

### CROSS REFERENCE TO RELATED APPLICATION

This Application claims the benefit of priority under 35 U.S.C § 120 of U.S. Provisional Application Ser. No. 62/908,154 filed on Sep. 30, 2019, the content of which is relied upon and incorporated herein by reference in its entirety.

### FIELD

Example embodiments of the present disclosure relate to aluminum titanate-cordierite ceramic bodies and more particularly to porous ceramic honeycomb bodies useful in high-temperature applications, such as in exhaust treatment applications.

### BACKGROUND

Aluminum titanate-based honeycombs have been widely used for a variety of exhaust mitigation/treatment applications, such as in particulate filters for diesel and gasoline engine emissions control.

Diesel particulate filters (DPF) and gasoline particulate filters (GPF) can be produced from a porous ceramic honeycomb body by plugging some channels in a plugging pattern to form a plugged honeycomb body. A portion of the channels can be plugged at the inlet end and/or outlet end with plugs. In some embodiments, a portion of the channels can be plugged at the outlet end but not on the inlet end, while another portion can be plugged at the inlet end and not on the outlet end.

In operation, the exhaust gas flows through at least some of the porous walls of the plugged ceramic honeycomb body. Along its flow path through the porous walls, particulates carried in the exhaust gas can be deposited on and/or within the porous walls, thus filtering particulates from the exhaust gas flow.

The above information disclosed in this Background section is only for enhancement of understanding of the disclosure and therefore it may contain information that does not form any part of the prior art nor what the prior art may suggest to a person of ordinary skill in the art.

### SUMMARY

Example embodiments of the present disclosure provide ceramic honeycomb bodies comprising a primary phase of aluminum titanate solid solution, and a secondary phase of cordierite, and wherein the ceramic honeycomb bodies comprise a material with relatively-low anisotropy.

Example embodiments of the present disclosure also provide ceramic honeycomb bodies comprising a primary phase of an aluminum titanate solid solution comprising a pseudobrookite crystalline structure, and a secondary phase of cordierite, and wherein ceramic honeycomb bodies comprise a material with reduced anisotropy as expressed by the aluminum titanate solid solution having a relatively-low AT tangential/axial i-ratio.

Example embodiments of the present disclosure also provide a batch mixture useful for the manufacture of such ceramic honeycomb bodies comprising the primary phase of an aluminum titanate solid solution comprising a pseudobrookite crystalline structure and a secondary phase of cordierite, wherein ceramic honeycomb bodies produced from the batch mixture comprise a material with relatively-low anisotropy. The relatively-low anisotropy is produced at least in part by utilizing spherical alumina in the batch mixture.

One or more example embodiments of the present disclosure also provide a method for manufacturing a ceramic honeycomb body comprising a primary phase of an aluminum titanate solid solution comprising a pseudobrookite crystalline structure and a secondary phase of cordierite, wherein ceramic honeycomb bodies comprise a material with relatively-low ani sotropy.

In another embodiment of the disclosure, a ceramic honeycomb body is provided that comprises a ceramic material comprising a primary phase of aluminum titanate solid solution comprising a pseudobrookite structure having a AT tang/axial i-ratio≤1.35, and a secondary crystalline phase of cordierite.

Some example embodiments of the disclosure provide an aluminum titanate-cordierite ceramic honeycomb body. The aluminum titanate-cordierite ceramic honeycomb body comprises a ceramic material comprising a primary phase of aluminum titanate solid solution comprising a pseudobrookite structure, and a secondary phase of cordierite, wherein low anisotropy is demonstrated by the aluminum titanate solid solution phase comprising a pseudobrookite structure having an AT tangential/axial i-ratio≤1.35. In example embodiments, the AT tang/axial i-ratio≤1.30, AT tang/axial i-ratio≤1.20, or even AT tang/axial i-ratio≤1.10 are demonstrated. In some embodiments, the ceramic honeycomb body comprises 1.00≤AT tang/axial i-ratio≤1.26.

Another example embodiment discloses a ceramic honeycomb body comprising a ceramic material with a primary phase of aluminum titanate solid solution comprising a pseudobrookite structure in a weight percentage of greater than or equal to 50 wt. % and a secondary phase of cordierite in a weight percentage of greater than or equal to 20 wt. %, each based on a total weight of inorganics in the ceramic material;
40%≤% P≤70%;
10 μm≤d₅₀≤30 μm, wherein d₅₀ is a median pore diameter;
d_{f}≤0.30; and
CTE≤10.0×10⁻⁷/° C., wherein CTE is a coefficient of thermal expansion of the ceramic honeycomb body as measured between 25° C. and 800° C. in a tangential direction, and

wherein low anisotropy is demonstrated by the primary phase of aluminum titanate solid solution by comprising an AT tangential/axial i-ratio≤1.35.

In another example embodiment, a batch mixture is disclosed. The batch mixture comprises a spherical alumina source having less than 3.0 wt. % silica content based on a total weight of the spherical alumina source; a titania source; a magnesia source; a silica source, and wherein, as expressed in weight percent on an oxide basis, the batch mixture comprises from 40 wt. % to 44 wt. % alumina, from 32 wt. % to 34 wt. % titania, from 6 wt. % to 10 wt. % magnesia, from 13 wt. % to 18 wt. % silica, and from 0.5 wt. % to 5 wt. % of a sintering aid. In some embodiments, the sintering aid can comprise from 1.0 wt. % to 2.0 wt. % of ceria (CeO₂), as expressed in weight percent on an oxide basis.

Yet another example embodiment discloses a method of manufacturing a ceramic honeycomb body. The method comprises mixing a batch mixture of: inorganic particulates, comprising: a spherical alumina source having less than 3.0 wt. % silica content based on a total weight of the spherical alumina source, a titania source, a magnesia source, and a silica source, wherein, as expressed in weight percent on an oxide basis, the batch mixture comprises from 40 wt. % to 44 wt. % alumina, from 32 wt. % to 34% titania, from 6 wt. % to 10 wt. % magnesia, from 13 wt. % to 18 wt. % silica, and from 0.5 wt. % to 5 wt. % of a sintering aid; a pore former in a range from 5 wt. % SA to 40 wt. % SA wherein wt. % SA is weight percent by superaddition based on 100% of the total weight of the inorganics; one or more processing aids; and a liquid vehicle; shaping the batch mixture into a green honeycomb body by extruding the batch mixture through an extrusion die comprising slots; and firing the green honeycomb body under firing conditions effective to cause conversion into the ceramic honeycomb body comprising a ceramic material of a primary phase of aluminum titanate solid solution comprising a pseudobrookite structure in a weight percentage greater than or equal to 50 wt. %, and a secondary phase of cordierite in a weight percentage greater than or equal to 20 wt. %, each based on a total weight of inorganics in the ceramic material, and wherein low anisotropy is demonstrated by the primary phase of aluminum titanate solid solution by comprising an AT tangential/axial i-ratio≤1.35.

Additional features of the disclosure will be set forth in the description which follows, and in part will be apparent from the description, or may be learned by practice of the embodiments disclosed herein. It is to be understood that both the foregoing general description and the following detailed description provide numerous examples and are intended to provide further explanation of the disclosure.

### BRIEF DESCRIPTION OF THE DRAWINGS

The accompanying drawings are included to provide a further understanding of the disclosure and are incorporated in and constitute a part of this specification, illustrate exemplary embodiments, and together with the description serve to explain the principles of the disclosure. The drawings are not necessarily drawn to scale. Like reference numerals are used to denote the same or substantially similar parts.

FIG. 1A illustrates a perspective view of a ceramic honeycomb body comprising a ceramic material including a primary phase of aluminum titanate solid solution comprising a pseudobrookite structure and a secondary phase of cordierite according to embodiments of the disclosure.

FIG. 1B illustrates an enlarged end view of a portion of the ceramic honeycomb body of FIG. 1A illustrating an example cell structure according to embodiments of the disclosure.

FIG. 1C illustrates a perspective view of a plugged ceramic honeycomb body comprising a ceramic material including a primary phase of aluminum titanate solid solution comprising a pseudobrookite structure and a secondary phase of cordierite according to embodiments of the disclosure.

FIG. 1D illustrates a flowchart of a method of manufacturing a ceramic honeycomb body comprising a ceramic material including a primary phase of aluminum titanate solid solution comprising a pseudobrookite structure and a secondary phase of cordierite according to embodiments of the disclosure.

FIG. 2 illustrates a partially cross-sectioned side view of an extruder shown extruding a green honeycomb body through slots of a honeycomb extrusion die according to embodiments of the disclosure.

FIGS. 3A-3C illustrates representative micrographs of polished cross-sections of porous walls of example ceramic bodies comprising a ceramic material including a primary phase of aluminum titanate solid solution comprising a pseudobrookite structure and a secondary phase of cordierite.

FIG. 4 illustrates a flowchart of a method of manufacturing a ceramic body according to embodiments of the disclosure.

### DETAILED DESCRIPTION

The disclosure is described more fully hereinafter with reference to the accompanying drawings and tables, in which example embodiments are shown and described. The disclosure may, however, be embodied in many different forms and should not be construed as limited to the embodiments set forth herein. Rather, these described embodiments are provided so that this disclosure is thorough, and will fully convey the scope of the disclosure to those skilled in the art. In the drawings, the size and relative sizes of features and components may be exaggerated for clarity and thus may not be drawn to scale. Like reference numerals in the drawings may denote like elements.

It will be understood that when an element is referred to as being “on,” “connected to,” or “coupled to” another element, it can be directly on or directly connected to the other element, or an intervening or interconnecting element may be present. In contrast, when an element is referred to as being “directly on” or “directly connected to” another element, there is no intervening element present.

Diesel and gasoline particulate filters find wide application in the automotive industry to filter soot and other particles from the exhaust gas stream and, in case of catalyst-containing honeycombs, can also contribute to CO, HC, SOx, and/or NOx abatement of the exhaust gas. In some embodiments integrated functionality is desirable by including combined catalysts (e.g., diesel oxidation catalysts (DOC), 3-way catalyst, and/or SCR catalysts) in a particulate filter and yet still providing suitably low backpressure so as not to appreciably restrict engine power, all while preserving acceptable thermal shock resistance.

A number of different materials are available for use in particulate filters, such as cordierite, aluminum titanate (AT), aluminum titanate-cordierite composites, silicon carbide, and mullite, among others. It is desirable that filter materials exhibit high thermal shock resistance (TSR) within the operational temperature range of the filter, which can extend from −30° C. to above 1,200° C. under controlled and uncontrolled regeneration. Cordierite and aluminum titanate-based materials are suited for such applications, since they have low coefficients of thermal expansion (CTE). However, the manufacturing processes used in the creation of both cordierite and aluminum titanate and known aluminum titanate-cordierite composite materials may result in anisotropic crystal structures that yield anisotropy in the thermomechanical properties of ceramic articles made from such materials. For example, cordierite, aluminum titanate (AT), and aluminum titanate-cordierite composite materials can have negative thermal expansion in the crystallographic direction and positive thermal expansion in other crystallographic directions.

Aluminum titanate pseudobrookite crystals show particularly large crystallographic anisotropy in thermal expansion. Thus, AT-containing filters made by current manufacturing processes may demonstrate low thermal expansion in their axial direction, but may undesirably show a strong anisotropy in many thermomechanical properties, including thermal expansion coefficient (CTE), elastic modulus, thermal conductivity, modulus of rupture, and/or others. Upon evaluation by the inventor herein, this anisotropy is believed to be caused by the traditional processing of honeycombs bodies for DPF or GPF filters, such as when formed by extrusion of a batch mixture of inorganic powders, a pore former, processing aids, and a liquid vehicle through narrow slots of an extrusion die to form a green honeycomb body followed by drying and reactive firing of the green honeycomb body to form a ceramic honeycomb body.

More particularly, raw material particles such as inorganic particles with an extended particle shape (plate-like or rods-like shapes) may preferentially align during extrusion when extruded through the narrow slots of the extrusion die. As such, their long axes are preferentially oriented along the extrusion direction of the honeycomb extrudate. For example, preferential alignment happens for platy alumina batch materials. Preferential alignment of grains in cordierite and AT-containing honeycomb bodies can be caused by growth modes during reactive sintering, either, for AT, by templated growth of aluminum titanate on the surface of the alumina raw material particles that have been aligned during extrusion, and/or, for cordierite, by growth via glass and liquid phases, which due to shear stresses during extrusion, are more aligned in the extrusion direction than perpendicular to it. Thus, conventionally, the grains are aligned with their long dimensions extending along the extrusion direction, which is the axial direction along the extruded honeycomb body. In traditional cordierite and AT-containing materials that direction also corresponds to the low expansion direction for both.

In AT-containing ceramic honeycomb bodies, the batch material can be made from an inorganic powder mixture that contains at least sources of alumina and titania, but may also include other stabilizers such as magnesia (MgO) and/or silica (SiO₂) components for the formation of aluminum titanate solid solutions, and/or secondary phases, such as feldspar, cordierite, mullite, and the like. The batch mixture is reactive and transforms during high temperature firing by a series of solid state reactions into the aluminum titanate-containing ceramic honeycomb body. Many of the raw materials in the batch mixture have a plate-like particle shape.

It was demonstrated in “Aluminum titanate composites for diesel particulate filter applications,” by Monika Backhaus-Ricoult, Chris Glose, Patrick Tepesch, Bryan Wheaton, and Jim Zimmermann, Proceedings from the International Conference of Ceramics and Composites, 2010, that alumina can serve as a template for aluminum titanate growth with a positive expansion a-axis of aluminum titanate ceramic being the preferred growth direction, so that the negative expansion c-axis of the aluminum titanate ceramic lies along the alumina plate plane. This leads to a preferential alignment of the negative expansion direction throughout the grains of the aluminum titanate honeycomb body in the axial direction (i.e., along the direction of the honeycomb extrusion direction), and a preferential alignment of the positive expansion direction in the tangential direction.

In ceramics (including ceramic honeycomb bodies), variation in the local orientation of crystalline grains with very strong crystallographic anisotropy and associated strong anisotropy in their thermal expansion drives microcracking in the ceramic microstructure and lowers the overall thermal expansion, thermal conductivity, and/or elastic modulus of the material.

If the grains with strong anisotropy in crystallographic lattice expansion are aligned in the ceramic material, then microcracking will preferentially occur in a corresponding direction and lead to low thermal expansion in one direction and high thermal expansion in another (as compared to an un-microcracked body). Thermal expansion and other thermomechanical properties will then be anisotropic. The anisotropy in the thermomechanical properties of the material corresponds with the preferential alignment of the crystalline phases in the ceramic honeycomb body that has undergone microcracking and, therefore, can be predicted/identified via a texture analysis of the ceramic material, in which preferential alignment of the microcracked phases is identified and quantified. Microcracked phases in the present materials include aluminum titanate and cordierite.

As stated above, variations in anisotropy in thermomechanical material properties are a result of the crystallographic texturing of the material. A hypothetical polycrystalline material built of a multitude of individual grains with a hypothetically purely random orientation is crystallographically isotropic and shows the same material properties in all of its directions. If the crystal structure of the grains is not cubic, but shows a non-symmetric crystal structure and the grains are no longer randomly oriented in the material then the material properties are anisotropic. The anisotropy of a polycrystalline ceramic material can be determined grain by grain by scanning the grain orientation (by backscattered electron diffraction, for example) or it can be determined globally for the entire material by determining an average preferred alignment of the grains. For the latter, either spatially-resolved information can be averaged (for example in form of pole figures of electron backscattered local orientation maps or by using ratios of various X-ray diffraction peak intensities (referred to herein as i-ratios, which are described in more detail below).

As disclosed herein, X-ray diffraction (XRD) of extruded ceramic materials was used, and variations in intensity of certain chosen peaks were examined. In particular, peak intensities in the axial (extrusion) direction and in the tangential direction (perpendicular to the axial direction) were examined. Since cordierite and aluminum titanate phases have a non-isotropic crystal structure, i-ratios for both phases are described herein. The material texturing studied herein is characterized by these i-ratios.

Evaluation of texturing by the inventor was undertaken on both green and fired honeycomb bodies by analyzing x-ray diffraction (XRD). Using XRD, the relative peak intensities of major peaks were compared in terms of intensity ratio (hereinafter i-ratio), and, in particular, i-ratios of the materials in the axial and tangential directions of the honeycomb body were determined. In the evaluation, the i-ratio of various materials were evaluated, wherein i-ratios for the aluminum titanate (AT) phase in axial and tangential directions are defined with respect to the designated lattice planes herein as:

Axial AT i-ratio=(200)/(002+200)

Tangential AT i-ratio=(200)/(200+002)

In addition, the i-ratio of the cordierite phase was also evaluated, wherein i-ratio for the cordierite phase is defined herein as:

Cordierite i-ratio=(110)/(110+002)

For conventional AT pseudobrookite phase, the crystallographic [001] axis is the negative expansion direction, and the directions perpendicular to it have positive expansion. Theoretically, the axial and tangential AT i-ratios can range from 0 to 1.0. If the AT grains were all perfectly aligned with their negative expansion direction by being aligned with the extrusion direction (axial axis of the honeycomb body), then the axial AT i-ratio would be 0, and the tangential AT i-ratio would be 1.0. In theory, if the AT grains negative expansion direction were all perfectly aligned in a tangential direction, then the axial AT i-ratio would be 1.0 and the tangential AT i-ratio would be 0. As was discovered by the inventor, the driver for the preferential alignment of AT pseudobrookite with its negative expansion direction in the extrusion direction (along the honeycomb axial axis) is the alignment of the platy alumina particles in the batch mixture (paste) during extrusion through the narrow slots of the extrusion die. The larger alumina plate surfaces are aligned in the extrusion direction, so that more alumina surface is available in the extrusion direction than in the radial directions. The inventor has further discovered that the availability of alumina particle surface area in the extrusion direction compared to availability perpendicular to it increases with the alumina raw material particle size and the aspect ratio of the particles.

In particular, aluminum titanate pseudobrookite grows on alumina raw material particle surfaces with its fast growing, highest expansion direction perpendicular to the alumina substrate surface. If the highest expansion direction points perpendicular to the extrusion direction, then the negative expansion direction is preferentially found in the axial direction along the axis of the honeycomb body. Since the thermal expansion of pseudobrookite in its main crystallographic directions is highly anisotropic, a preferred alignment of the negative expansion direction along the axis will yield anisotropy in the thermomechanical properties of the material of the honeycomb body that grows with increasing alignment of the pseudobrookite AT.

As a consequence, the thermomechanical properties of the material of the ceramic honeycomb body are anisotropic resulting in lower coefficient of thermal expansion (CTE) in the axial direction and higher CTE occurring in the radial direction in conventional AT-based ceramics honeycomb bodies. The preferential alignment can provide similarly anisotropic elastic modulus, modulus of rupture (MOR), thermal conductivity, and thermal shock resistance (TSR).

Such anisotropy in the thermomechanical properties can, in some instances, result in undesirable cracking of the ceramic honeycomb body. For example, in operation such as during an uncontrolled regeneration event, the ceramic honeycomb body, such as of a particulate filter, can be exposed to severe temperature gradients, which, in the case of large CTEs in the radial direction of the ceramic honeycomb body, can cause cracking, and can thus limit the filter's temperature operating window. Thus, it should be recognized that conventional extrusion methods through slots of extrusion dies using conventional AT batch mixtures provide ceramic honeycomb bodies that exhibit substantial anisotropy.

In ceramic honeycomb bodies, variations in the local orientation of the crystalline grains with strong crystallographic anisotropy yield associated strong anisotropy in material properties. The inventors have discovered that if a more random orientation of the grains can be achieved, then microcracking occurs more randomly, and with less preferential direction. The thermomechanical properties (e.g., thermal expansion, thermal conductivity, and elastic modulus) of the material of the resulting ceramic honeycomb body can be provided more homogeneously in all directions within the ceramic, i.e., the thermomechanical properties can become more substantially isotropic.

In view of the problems of the prior art conventional AT-based, cordierite-based, and composite AT-cordierite based ceramics, in one or more embodiments, the inventors herein have discovered methods of manufacture and batch mixtures that result in AT-based ceramic materials and AT-based ceramic honeycomb bodies that have materials that exhibit relatively-low anisotropy in their thermo-mechanical properties. (i.e., that have improved isotropic properties).

Some example embodiments that have improved isotropic properties comprise a composite aluminum titanate-cordierite ceramic. The aluminum titanate-cordierite composite material comprises a primary pseudobrookite phase of an aluminum titanate-magnesium titanate solid solution and a secondary phase of cordierite and shows very low anisotropy. The lower texture alignment of the grains in the material can be expressed in terms of the i-ratios for cordierite and pseudobrookite. The relatively-low anisotropy is demonstrated, in part, by the primary aluminum titanate solid solution phase (made from batch mixtures with spherical alumina material) having an AT tang/axial i-ratio≤1.35.

In another embodiment of the disclosure, a ceramic honeycomb body manufactured from a batch mixture comprising spherical alumina batch material is provided that comprises a ceramic material comprising a primary phase of aluminum titanate solid solution comprising a pseudobrookite structure having an AT tang/axial i-ratio≤1.35, and a secondary crystalline phase of cordierite.

Further, the thermomechanical properties of the AT-based ceramic honeycomb bodies produced by the method of manufacturing methods and from the batch mixtures described herein advantageously provide substantially more isotropic thermomechanical properties in the ceramic honeycomb body, such as lower anisotropy in CTE, elastic modulus (E), modulus of rupture (MOR), thermal conductivity, and/or thermal shock resistance (TSR). This naturally leads to a substantially-reduced propensity of the ceramic articles to crack. Furthermore, the substantially lower anisotropy in thermo-mechanical properties can lead to an enhanced wider operating temperature window for DPF and GPF filters. In particular, ceramic honeycomb bodies with lower anisotropy in thermo-mechanical properties can exhibit less difference in axial and radial thermal expansion, which can result in lowered crack formation under the stresses of uncontrolled regeneration.

In other embodiments, aluminum titanate-containing ceramic bodies are provided that comprise a primary aluminum titanate solid solution phase having a pseudobrookite structure that comprises relatively-low anisotropy as demonstrated by the primary aluminum titanate solid solution phase having an AT tang/axial i-ratio≤1.35, and a secondary cordierite phase.

In some embodiments, catalytic converters and particulate filters are provided comprising porous ceramic honeycomb bodies that further comprise a material containing a primary aluminum titanate solid solution phase having a pseudobrookite structure that comprises relatively-low anisotropy as demonstrated by the primary aluminum titanate solid solution phase having an AT tang/axial i-ratio≤1.35, and a secondary cordierite phase.

Moreover, porous ceramic honeycomb bodies are provided comprising a material containing a primary aluminum titanate solid solution phase having a pseudobrookite structure, and a secondary cordierite phase, wherein the porous ceramic honeycomb bodies further exhibit improved isotropic thermo-mechanical material properties such as CTE.

In summary, advantages of improved-isotropic ceramic honeycomb bodies include the ability to provide one or more of a wider temperature operating window in use, lessened propensity to crack in use, especially during regeneration events, enabling either higher washcoat loading, higher porosity, larger pore size, and/or higher material strength without loss of other thermomechanical properties, or combinations of the afore-mentioned.

In some embodiments, the porous ceramic honeycomb bodies are provided comprising lowered anisotropy in thermo-mechanical properties by using spherical alumina within a reactive aluminum titanate-cordierite composite-forming batch mixture. The aluminum titanate-cordierite composite-forming batch mixture can comprise spherical alumina that can be produced by any suitable method, such as by spray drying. According to embodiments disclosed herein, the source of spherical alumina is substantially pure, having less than 3 wt. % of silica therein, based on the total weight of the spherical alumina from that source.

In one aspect, the improved (lowered) anisotropy is provided by suppressing the preferred growth of AT in the radial direction of the honeycomb article by suppressing the anisotropy in the alumina template shape. In particular, the suppression is provided by providing alumina raw material particles in the batch mixture that exhibit a substantially-spherical shape. Since spherical particles are round in shape, they do not align with the extrusion direction as a result of extrusion through narrow slots, unlike platy particles as discussed above. Furthermore, the substantially-spherical alumina shape yields isotropic growth of AT pseudobrookite on all alumina sphere surfaces with its highest expansion direction pointing in radial direction of the particle and the low expansion direction preferentially pointing perpendicular to it. As a result, minimal or no preferential alignment of AT pseudobrookite grains develops during firing due to templated growth on the substantially spherical alumina surfaces. The result is a fired honeycomb body of an AT-based ceramic material with lower anisotropy than a fired AT-based honeycomb body made from traditional reactive batches.

Use of substantially-spherical alumina in the batch mixture can further yield improved chemical homogeneity of the plasticized batch mixture (paste) including one or more of improved mixing, improved distribution, and improved suppression of agglomerates. Improved homogeneity in the density of the plasticized batch mixture can result in fewer fluctuations in particle packing due to alumina spheres of narrow particle size distribution (NPSD) compared to a wide range of shape and sizes of alumina sources in conventional AT-containing reactive batches. As a result, lower defect densities in green and fired honeycomb bodies could be expected, that can result in improved mechanical properties. For example, higher MOR and improved isostatic strength can occur at the same CTE.

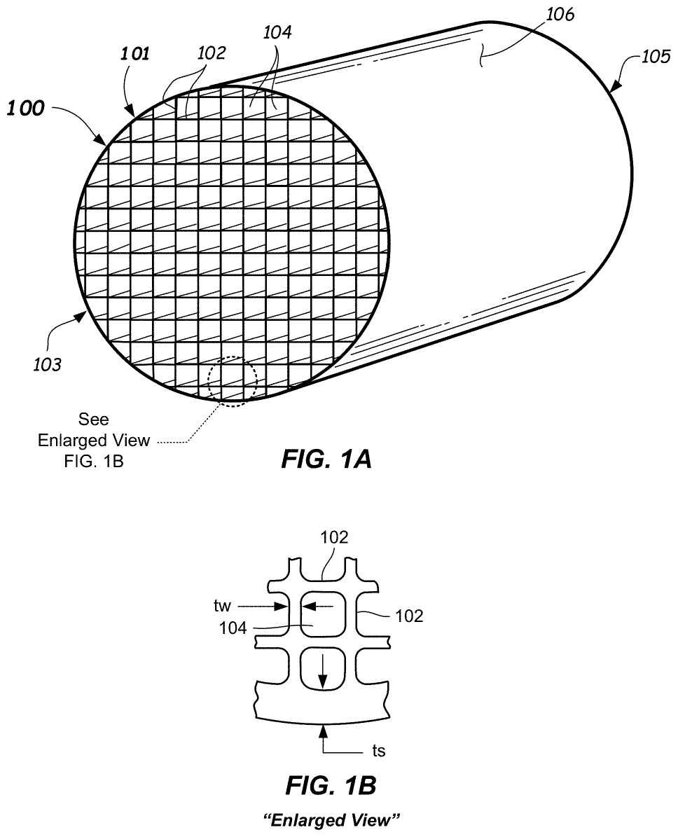

Various embodiments of the disclosure will now be described with reference to the Tables and FIGS. 1A-4 disclosed and described herein. The ceramic honeycomb body 100 as shown in FIGS. 1A and 1B comprises a matrix 101 of intersecting porous walls 102 forming a monolithic assembly including a honeycomb of channels 104 that extend parallel to one another along an axial length of the ceramic honeycomb body 100 from a first end 103 (e.g., an inlet end) to a second end 105 (e.g., an outlet end). The channel shape in transverse cross-section, as defined by the location, shape, and arrangement of the walls 102 in the matrix can be square as shown in FIGS. 1A and 1B. However, alternatively, the transverse cross-sectional channel shape can be rectangular (non-square), triangular or tri-lobed, pentagonal, hexagonal, octagonal, diamond, circular, oval, other polygonal shapes, and combinations of the aforementioned. Some or all of the channels 104 can have rounded corners, chamfered corners, square corners, or combinations thereof.

### Wall Thickness (tw)

The ceramic honeycomb body 100 can comprise a configuration having, for example, a transverse wall thickness tw of the walls 102 ranging from 0.002 inch to 0.020 inch (0.051 mm to 0.508 mm—see FIG. 1B), or even from 0.004 inch to 0.014 inch (0.102 mm to 0.356 mm) in some embodiments. Furthermore, the intersecting porous walls 102 can be of a substantially constant wall thickness tw across the ceramic honeycomb body 100. Optionally, the wall thickness tw can be of varying thickness. For example, the wall thickness tw of the intersecting porous walls 102 can be made thicker in certain portions of the ceramic honeycomb body 100, such as near the skin 106 of the ceramic honeycomb body 100, to provide a halo of thicker walls adjacent to the skin 106. The skin 106 can be extruded along with the matrix 101 in some embodiments, or can be an after-applied skin applied as a cement mixture to an extruded periphery of the matrix 101.

In some embodiments, the ceramic honeycomb body 100 has certain ones of the channels 104 that are further processed to include plugs 107 at or near the ends 103, 105 as is shown in FIG. 1C, thus forming a plugged honeycomb body 100P. Plugs 107 can be formed by any suitable plugging process. In the depicted embodiment of FIG. 1C, the inlet end 103 can include plugs 107. The outlet end 105 (not shown) can include plugs 107 on the channels 104 that are unplugged at the inlet end 103. Thus, each end comprises a checkerboard pattern of plugs 107. Other plugging patterns can be used, including those with some channels 104 that are unplugged, thus providing a partial filter.

### Cell Densities (CD)

The ceramic honeycomb body 100 of FIG. 1A or plugged ceramic honeycomb body 100P of FIG. 1C, can be formed to comprise an average cell density (CD) ranging from an average cell density of 15.5 cells/cm² to 77.5 cells/cm² (100 cpsi to 500 cpsi), for example. Other average cell densities (CD) can be used. Cell densities may be alternatively referred to as cells per square inch, or cpsi. One example honeycomb geometry of the ceramic honeycomb body 100 may comprise an average cell density of 400 cpsi (62 cells/cm²) with a wall thickness (tw) of about 8 mils (0.20 mm) defined herein as a 400/8 ceramic honeycomb body. In another embodiment, a 400/6 ceramic honeycomb body can comprise an average cell density of 400 cpsi (62 cells/cm²) and a wall thickness of about 6 mils (0.15 mm). Besides the 400/8 and 400/6 geometries, other suitable honeycomb geometries of the ceramic honeycomb body 100 or plugged honeycomb body 100P can include, for example, combinations of CD/tw of 100/17, 200/8, 200/12, 200/19, 270/19, 300/8, 300/12, 300/15, and 350/12. Other suitable combinations of cell density CD and wall thickness can be used.

In particulate filter embodiments, e.g., the plugged honeycomb body 100P, certain ones of the channels 104 are plugged. For example, as shown in FIG. 1C, a plugged ceramic honeycomb body 100P is shown that can be included in a diesel particulate filter (DPF) for a diesel engine, or gasoline particulate filter (GPF) for a gasoline engine application, such as through a conventional canning process.

In the depicted embodiment of FIG. 1C, for example, the plugged ceramic honeycomb body 100P can include the same-sized inlet channels and outlet channels, such as disclosed in U.S. Pat. Nos. 4,329,162, 6,849,181, and 8,512,433, for example. In such embodiments, roughly 50% of the channels 104 can be plugged at the inlet end 103 as shown, but are open (unplugged) at the outlet end 105, thus constituting outlet channels. Likewise, the other channels 104 that are unplugged at the inlet end 103 can be plugged at the outlet end 105 and thus constitute inlet channels. Therefore, in some embodiments, each channel 104 is plugged only at one end. Other filter plugging patterns are possible, such as disclosed in U.S. Pat. Nos. 4,417,908, 8,236,083, 8,673,064, 8,844,752, 9,757,675, and US2019/0126186, for example. In some embodiments of plugged honeycomb body 100P, some of the channels 104 can have a larger hydraulic diameter and other ones can have smaller hydraulic diameter, such as described in, for example, U.S. Pat. Nos. 6,696,132, 6,843,822, 7,247,184, and 7,601,194.

In the plugged honeycomb body 100P, any suitable plugging method or plugging material can be used, such as described in U.S. Pat. Nos. 4,329,162, 4,557,773, 4,573,896, 4,715,801, 6,673,300, 7,744,669, 7,803,303, 7,922,951, US2009/0295009, and US2009/0140453. The plugging can be provided at the inlet end 103 and outlet end 105 of the channels 104 and can be plugged to a depth of about 5 mm to 20 mm, although this can vary. In some embodiments, not all channels 104 contain plugs 107. For example, some channels 104 may be unplugged flow-through channels.

The outermost shape of the ceramic honeycomb body 100 (and the plugged honeycomb body 100P) can have any desired outer cross-sectional shape for the application, such as a circular outer cross-section (as shown in FIGS. 1A and 1C), an ellipse, an oval, a triangular or tri-lobed shape, a square or rectangular shape, or other polygonal cross-sectional outer shape. However, the honeycomb body 100 and plugged honeycomb body 100P are not limited to these cross-sectional shapes. Other cross-sectional shapes can be used. The term ceramic honeycomb body, as used herein broadly includes, but is not limited to, ceramic honeycomb bodies 100 that are unplugged as well as plugged honeycomb bodies 100P.

The ceramic honeycomb body 100 (and the plugged honeycomb body 100P) can be wash-coated with a catalyst-containing washcoat to form a catalyzed ceramic honeycomb body 100 or catalyzed and plugged honeycomb body 100P. The catalyzed ceramic honeycomb body 100 or catalyzed and plugged honeycomb body 100P can be provided in applications for filtration of particles and abatement of NOx, SOx, HC, and/or CO in any vehicle exhaust.

### Ceramic Honeycomb Material

As briefly summarized above, some embodiments of the present disclosure provide a ceramic honeycomb body 100, 100P having a matrix 101 of porous walls 102 comprising an AT-based ceramic material. The ceramic material of the matrix 101 contains, in embodiments described herein, a primary aluminum titanate solid solution phase comprising a pseudobrookite structure and having an AT tang/axial i-ratio≤1.35, and a secondary crystalline phase of cordierite.

In some embodiments, the primary aluminum titanate solid solution phase comprises an AT tang/axial i-ratio≤1.30, an AT tang/axial i-ratio≤1.20, or even an AT tang/axial i-ratio≤1.10. In some embodiments, the AT tang/axial i-ratio of the primary aluminum titanate solid solution phase can range between 1.00≤tang/axial i-ratio≤1.26. The nearer the value of tang/axial i-ratio is to 1.00, the more isotropic are the thermomechanical properties of the material of the ceramic honeycomb body 100, 100P.

Table 1 below provides several example embodiments of AT-based ceramic materials made with spherical alumina illustrating a preferred crystallographic alignment of the primary aluminum titanate-containing AT phase and the secondary cordierite phase in form of tang/axial i-ratios for the primary aluminum titanate-containing phase (AT Tang/Axial i-ratio) and additionally for the secondary cordierite phase (Cord Axial/Tang i-ratio).

TABLE 1
Comparison of AT axial and tangential i-ratios and cordierite axial and
tangential i-ratios for ceramic honeycomb bodies made from batch mixtures
containing substantially-pure spherical alumina (Example ‘A’, Example
‘B’) and calcined, spray-dried spherical alumina (Example ‘C’).

| | | Top Firing | | | AT | | | Cord |
|---|---|---|---|---|---|---|---|---|
| | Mixture | Temp/Hold | Tang | Axial | Tang/ | Tang | Axial | Tang/ |
| Sphere | Example | Time | AT | AT | Axial | Cord | Cord | Axial |
| Type | Name | (° C./hr) | i-ratio | i-ratio | i-ratio | i-ratio | i-ratio | i-ratio |
| Reactive | ‘A’ | 1355/22 | 0.79 | 0.59 | 1.34 | 0.79 | 0.67 | 1.18 |
| Alumina | | | | | | | | |
| Spheres 1 | | | | | | | | |
| Reactive | ‘B’ | 1355/22 | 0.77 | 0.63 | 1.22 | 0.73 | 0.66 | 1.11 |
| Alumina | | | | | | | | |
| Spheres 2 | | | | | | | | |
| Spray | ‘C’ | 1355/22 | 0.75 | 0.57 | 1.32 | 0.72 | 0.64 | 1.13 |
| Dried | | | | | | | | |
| Alumina | | | | | | | | |
| Spheres | | | | | | | | |

As can be seen from Table 1 above, use of spherical alumina particles in the batch mixture along with other reactive batch particles can substantially reduce the anisotropy of the AT solid solution phase in the extruded, fired honeycomb material. For example, some embodiments exhibit an AT tang/axial i-ratio≤1.35 for the listed sphere type and firing conditions. Some embodiments can have AT tang/axial i-ratio≤1.25. The depicted embodiments can achieve 1.20≤AT tang/axial i-ratio≤1.35, which is substantially smaller than the AT i-ratio of greater than 1.45 (or more often greater than 1.6) that is reported for batch mixtures including platy alumina batch material.

In one or more embodiments, the mixture of the matrix 101 of the ceramic honeycomb body 100, 100P can be characterized as comprising, when expressed on weight percent oxide basis: from 40% to 44% Al₂O₃; from 32% to 34% TiO₂; 6% to 10% MgO; from 13% to 18% SiO₂, and from 0% to 5% of a sintering aid, and in some embodiments from 0.5% to 5% of a sintering aid.

In the aluminum titanate-cordierite composite mixture described above, the mixtures are expressed in terms of weight fractions of oxides on an oxide basis. It will be recognized that the oxides used to define the oxide mixtures of these ceramics will not necessarily be present in the ceramic honeycomb bodies 100, 100P as corresponding free oxides or such oxide crystal phases, other than as those crystal phases that are specifically identified herein as being characteristic of these ceramic mixtures.

In example embodiments, the porous ceramic honeycomb body 100P can be included in a diesel particulate filter (DPF) or gasoline particulate filter (GPF) and can comprise a honeycomb structure having the matrix 101 comprising a plurality of axially extending end-plugged inlet channels and end-plugged outlet channels. In accordance with embodiments described herein, the ceramic honeycomb body 100, 100P comprising the ceramic mixture can further comprise combinations of certain microstructural and thermo-mechanical properties that are very desirable for use in particle filtration applications, such as in DPF and GPF applications.

For example, as described herein, the ceramic honeycomb bodies 100 can include a relatively-high level of average bulk porosity (% P) that is both open and interconnected porosity. Furthermore, porous walls 102 of the matrix 101 of the ceramic honeycomb body 100P, after firing, can comprise a median pore diameter (d₅₀) that enables good filtration efficiency as well as large enough average pore diameter (d₅₀) to enable good catalyst coating density and minimized back pressure. Furthermore, the distribution of the pore diameters in the porosity of the walls 102 of the matrix 101 can be made relatively narrow, thus improving both clean and soot loaded backpressure, and well as wash-coated backpressure. Furthermore, the above microstructural properties can be achieved while also providing relatively low CTE (measured from 25° C. to 800° C.) in one or more directions (axial and/or tangential direction). Furthermore, high strength may be provided, such as modulus of rupture (MOR) of MOR≥200 psi, or even MOR≥242 psi, when measured on a ceramic honeycomb body 100 having a 300/15 configuration of CD/tw.

### Average Bulk Porosity (% P)

Example embodiments of the ceramic honeycomb bodies 100 of the present disclosure can comprise a relatively-high level of average bulk porosity that comprises open and interconnected porosity. For example, ceramic honeycomb bodies 100, 100P containing the ceramic mixture described herein can comprise an average bulk porosity (% P) wherein % P≥40%, % P≥45%, % P≥50%, % P≥55%, % P≥60%, or even % P≥65%, in a range of 40%≤% P≤70%, 40%≤% P≤65%, 45%≤% P≤65%, 50%≤% P≤65%, or even 48%≤% P≤53%. Such ranges of porosity in the ceramic honeycomb body 100P in combination with the disclosed ceramic mixture can provide low backpressure when in used as plugged ceramic honeycomb bodies 100P of particulate filters, especially when comprising an in-the-wall washcoat containing a catalyst or a combined catalysts, while providing adequate thermal shock resistance (via low CTE). Average bulk porosity (% P) is determined by mercury intrusion porosimetry herein. Within the disclosed mixtures, average bulk porosity (% P) can be adjusted to a desired value within the above disclosed ranges by changing the alumina sphere diameter and/or the amount and/or type of pore former, and/or the pore former median particle diameter (dp₅₀).

In addition to the relatively-high average bulk porosity, ceramic honeycomb bodies 100 of the present disclosure can also comprise a relatively-narrow pore size distribution (NPSD). The NPSD can be evidenced by a minimized percentage of relatively-fine pore sizes, or minimized percentage relatively-large pore sizes, or minimized percentage of both relatively-fine and relatively-large pore sizes in some embodiments. Such NPSD has the advantage of aiding in the attainment of low back pressure even when coated with a catalyst(s)-containing washcoat, as fine pores can be minimized. Further, ceramic honeycomb bodies 100 having a matrix 101 with NPSD can be beneficial for providing low soot-loaded pressure drop as well as excellent soot capture efficiency (e.g., >95%) when the ceramic honeycomb body 100 is embodied as a plugged honeycomb body 100P in diesel and or gas engine exhaust filtration applications.

As described herein, pore size distributions are determined by mercury intrusion porosimetry using the Washburn equation. For example, the quantity d₅₀ represents the median pore diameter (MPD) based upon pore volume (measured in μm). In the measurement system, pressure is increased so that mercury penetrates narrower pore channels and fills an increasing volume of the porosity until a critical pressure is reached where the mercury spans the specimen. Thus, d₅₀ is the pore diameter at which 50% of the open porosity of the ceramic honeycomb body 100, 100P has been intruded by mercury. The quantity d₉₀ is the pore diameter at which 90% of the pore volume is comprised of pores whose diameters are smaller than the value of d₉₀; thus, d₉₀ is also equal to the pore diameter at which 10% by volume of the open porosity of the ceramic honeycomb body 100, 100P has been intruded by mercury. Still further, the quantity d₁₀ is the pore diameter at which 10% of the pore volume is comprised of pores whose diameters are smaller than the value of d₁₀; thus, d₁₀ is equal to the pore diameter at which 90% by volume of the open porosity of the ceramic honeycomb body 100, 100P has been intruded by mercury. The values of d₁₀ and d₉₀ are also expressed in units of μm. Pore size distributions of the ceramic honeycomb bodies 100, 100P were explored by mercury intrusion porosimetry using an Autopore® IV 9520 porosimeter.

d₅₀

In accordance with another aspect of the disclosure, the porous walls 102 of the ceramic honeycomb body 100, 100P, after firing, can comprise a median pore diameter (d₅₀) of d₅₀≥10.0 μm, d₅₀≥12.0 μm, d₅₀≥13.0 μm, d₅₀≥15.0 μm, d₅₀≥20.0 μm, or even of even d₅₀≥25.0 μm in some embodiments. Furthermore, the porous walls 102 of the ceramic honeycomb body 100, 100G, after firing, can comprise a median pore diameter (d₅₀) that ranges as follows: 10 μm≤d₅₀≤30 μm, 15 μm≤d₅₀≤30 μm, 20 μm≤d₅₀≤30 μm, or even 21 μm≤d₅₀≤28 μm in some embodiments. To this end, a combination of the aforementioned average bulk porosity (% P) and median pore diameter (MPD) can provide relatively-low clean and soot-loaded pressure drop, while maintaining useful filtration efficiency (>95%) when the ceramic honeycomb bodies 100 are embodied as plugged honeycomb bodies 100P used in DPF and GPF applications. Within the disclosed mixtures, MPD can be adjusted to a desired value within the above ranges by changing the median particle diameter (dp₅₀) of the alumina spheres in the batch mixture and/or the size and/or amount of the pore former used in the batch mixture.

d_{f}

The relatively-narrow pore size distribution of the pores of the ceramic honeycomb bodies 100, 100P can, in one or more embodiments, be evidenced by a relative width of the distribution of pore diameters. One suitable measure defines the distribution of particle diameters that are from d₁₀ to d₅₀, further quantified as pore fraction. As used herein, the width of the distribution of pore sizes form d₁₀ to d₅₀ are represented by a “d_{factor}” or a value of “d_{f}”, which expresses the quantity (d₅₀−d₁₀)/d₅₀. The narrowness of a portion of a lower pore fraction (equal to and above d₁₀ and equal to and below d₅₀) of the pore size distribution of the open, interconnected porosity of the ceramic honeycomb body 100, 100P can be characterized by d_{f}, wherein d_{f}={(d₅₀−d₁₀)/d₅₀}. NPSD is characterized by relatively-low values of d_{f} herein.

In example embodiments of the ceramic honeycomb body 100, 100P, a narrow pore size distribution is demonstrated by d_{f} that satisfies d_{f}≤0.50, d_{f}≤0.40; or even d_{f}≤0.30. In some embodiments, the ceramic material can exhibit d_{f}≤0.25, d_{f}≤0.20, or even d_{f}≤0.19. In some embodiments, the porous walls 102 of the ceramic honeycomb body 100, 100P, after firing, can comprise d_{f} of 0.16≤d_{f}≤0.50; 0.16≤d_{f}≤0.30, 0.16≤d_{f}≤0.25, 0.16≤d_{f}≤0.22, or even 0.16≤d_{f}≤0.20. Within the described mixtures, a relatively-low d_{f} coupled with a relatively-high MPD as described herein, indicates a low fraction of fine pores, and low values of df can be beneficial for ensuring low soot-loaded pressure drop when the ceramic honeycomb bodies 100 are embodied as plugged honeycomb bodies 100P and utilized in filtration applications.

### CTE

Even when including relatively-high porosity (% P≥40%) and relatively-coarse MPD (MPD≥10 μm), the coefficient of thermal expansion (CTE) of the ceramic honeycomb body 100, 100P comprising the aluminum titanate-cordierite ceramic material was discovered to be quite low. According to example embodiments, it was discovered that the present ceramic mixture exhibits a relatively-low CTE resulting in excellent thermal shock resistance (TSR) when used in a ceramic honeycomb body 100, 100P, for example. As will be appreciated, TSR is inversely proportional to CTE. That is, a ceramic honeycomb body 100, 100P with low CTE can also have higher TSR and may therefore survive wide temperature fluctuations that are encountered in, for example, exhaust filtration applications, such as during regeneration events.

Accordingly, in example embodiments, the ceramic honeycomb body 100, 100P of the present disclosure comprising the ceramic phase mixture described herein can exhibit a relatively-low CTE in at least one direction, as measured by dilatometry. In particular, CTE≤15.0×10⁻⁷/° C. can be achieved, wherein CTE is a coefficient of thermal expansion in at least one direction, as measured between 25° C. and 800° C. (25° C.-800° C.). In some embodiments, CTE≤10.0×10⁻⁷/° C. as measured between 25° C.-800° C. can be achieved in the tangential direction. In other embodiments, CTE≤8.0×10⁻⁷/° C., or even CTE≤4.0×10⁻⁷/° C. can be achieved as measured between 25° C.-800° C. in the tangential direction.

In some embodiments, the CTE across the temperature range of from 25° C. to 800° C. can be in a range from 2.0×10⁻⁷/° C.≤CTE≤10.0×10⁻⁷/° C. in the tangential direction, or even 2.0×10⁻⁷/° C.≤CTE≤8.0×10⁻⁷/° C. in the tangential direction. In some embodiments, CTE across the temperature range of from 25° C. to 800° C. can be in a range from 3.6×10⁻⁷/° C.≤CTE≤7.8×10⁻⁷/° C. as in the axial direction. CTE was measured parallel to the channels 104 (axial) and perpendicular to the channels 104 (tangential) by dilatometry.

In some embodiments, a ratio of tangential-to-axial CTE (Tang/Axial CTE ratio) provides another measure of the low anisotropy exhibited by embodiments of the ceramic honeycomb body 100, 100P comprising the ceramic material described herein. In some embodiments, the Tang/Axial CTE ratio at from 25° C. to 800° C. can be Tang/Axial CTE ratio≤1.35, Tang/Axial CTE ratio≤1.30, or even Tang/Axial CTE ratio≤1.26. In some embodiments, Tang/Axial CTE ratio can range from 1.00≤Tang/Axial CTE ratio≤1.35, or even between 1.00≤Tang/Axial CTE ratio≤1.26. This is much smaller than the Tang/Axial CTE ratio of greater than 1.45 that was observed for a reference AT-cordierite honeycomb material made using platy alumina in the batch mixture.

Thermal expansion was measured for bar-shaped samples with dimensions of approximately 0.25″×0.25″×2″ (0.64×0.64×5.1 cm) during heating from room temperature to 1,000° C. at a rate of 4° C./min and subsequent cooling to room temperature (25° C.). For the data reported, the long axis of the test bar was oriented in the direction of the honeycomb channels 104, thus providing the thermal expansion and CTE in the axial direction of the ceramic honeycomb body 100. Tangential average thermal expansion and CTE in the tangential direction of the honeycomb body 100 is perpendicular to the axial direction. Average thermal expansion coefficient (CTE) in each direction is measured from room temperature (RT) to 800° C. is defined as L(800° C.)−L(25° C.)/775° C.

### Combinations

Ceramic honeycomb bodies 100 comprising the ceramic material described herein can exhibit combinations of the aforementioned relatively-high average bulk porosity (% P), relatively-coarse median pore diameter (d₅₀), relatively-low d_{f}, and relatively-low CTE (25° C. to 800° C.) and can provide low clean and soot-loaded pressure drop, while maintaining useful filtration efficiency and improved TSR when the ceramic honeycomb body 100 of the present disclosure is embodied as a plugged honeycomb body 100P and used in DPF or GPF applications.

Particularly effective examples of ceramic honeycomb bodies 100, 100P can comprise the ceramic material as described herein and can further comprise microstructural properties (% P, d50, df) and thermomechanical properties (e.g., CTE (25° C.-800° C.)) of the material of the intersecting porous walls 102 wherein:

P %≥40%;

d₅₀≥10.0 μm, wherein d₅₀ is a median pore diameter;

df≤0.30; and

CTE≤10.0×10⁻⁷/° C. as measured from 25° C. to 800° C. in the tangential direction. Additionally, ceramic honeycomb bodies 100, 100P can comprise an Tang/Axial CTE ratio≤1.35, or even Tang/Axial CTE ratio≤1.26.

In further example embodiments, ceramic honeycomb bodies 100, 100P can comprise the ceramic material as described herein and can further comprise microstructural properties (% P, d50, df) and CTE (25° C. to 800° C.) of the material of the intersecting porous walls 102 of:

P %≥40%;

d₅₀≥20 μm;

d_{f}≤0.20;

CTE≤10.0×10⁻⁷/° C. as measured from 25° C. to 800° C. in the tangential direction; and

a tang/axial CTE ratio≤1.35.

In some other embodiments, the ceramic honeycomb bodies 100, 100P can comprise the ceramic material as described herein and can further comprise combinations of microstructural features (% P, d50, df) and CTE of the material of the porous walls 102 of the matrix 101 of:

40%≤P %≤70%;

a median pore diameter (d₅₀) of 10.0 μm≤d₅₀≤30.0 μm;

0.16≤d_{f}≤0.30; and

3.0×10⁻⁷/° C.≤CTE≤10.0×10⁻⁷/° C. measured from 25° C. to 800° C. in the tangential direction.

Remarkably, some example embodiments, the material of the porous walls 102 of the matrix 101 can achieve:

50%≥% P≥70%;

20 μm≤d₅₀≤30 μm;

0.16≥d_{f}≥0.20; and

3.0×10⁻⁷/° C.≤CTE≤10.0×10⁻⁷/° C., as measured between 25° C. and 800° C. in the tangential direction.

Such combinations of properties in the ceramic honeycomb bodies 100P are useful for use in DPF and GPF applications.

### Extrusion Methods

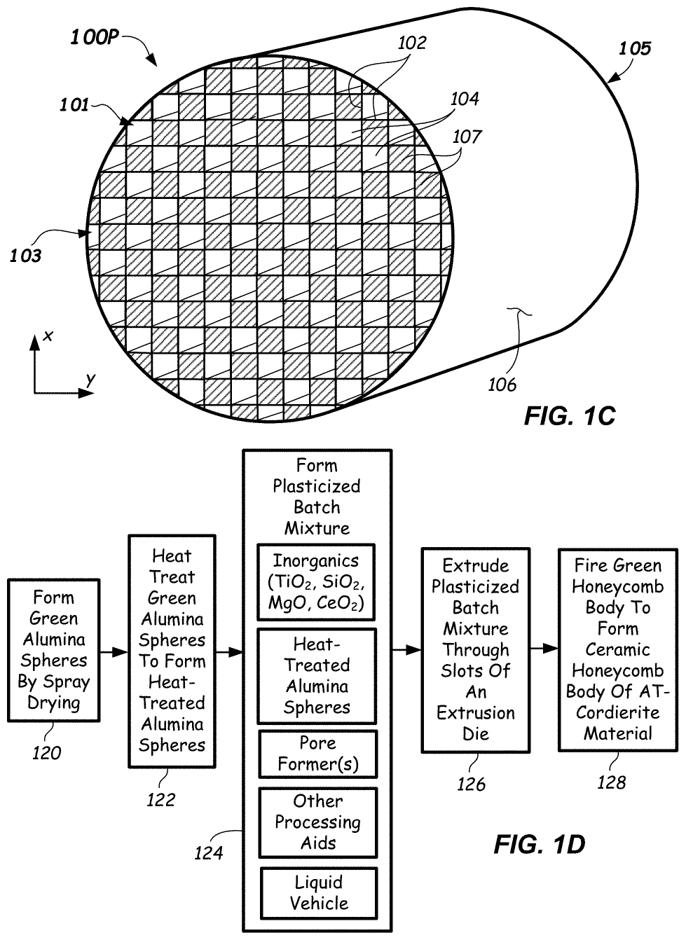

Referring now to FIG. 2, example embodiments of the present disclosure also provide methods of manufacturing the ceramic honeycomb bodies 100, 100P comprising the aluminum titanate-cordierite composite material from a batch mixture comprising certain inorganic raw material powders, organic material powders, a liquid vehicle (e.g., water), and optional processing aids. The methods of manufacturing the ceramic honeycomb bodies 100, 100P comprise providing an inorganic batch mixture comprising sources of spherical alumina, and particulate titania, silica, and magnesia, that can comprise selected particle sizes (e.g., d₅₀) and weight percentages (wt. %) as outlined herein. The inorganic batch mixture can then be mixed together with the organic powdered materials such as an organic binder (methocellulose or the like), one or more pore formers; the liquid vehicle; and one or more processing aid(s) such as a plasticizer or lubricant, to form a plasticized batch mixture 210. The plasticized batch mixture 210 can be shaped into a green honeycomb body 100G by an extrusion process through an extrusion die containing slots from which the walls of the honeycomb body 100G are formed.

The green honeycomb body 100G can then be dried and subsequently fired under conditions effective to convert the green honeycomb body 100G into a ceramic honeycomb body 100 comprising the afore-mentioned aluminum titanate-cordierite composite mixture.

For example, FIG. 2 illustrates a side cross-sectioned view of an example embodiment of an extruder 200 (e.g., a continuous twin-screw extruder). The extruder 200 includes a barrel 212 including a chamber 214 formed therein. The barrel 212 can be monolithic or it can be formed from a plurality of barrel segments connected successively in the axial direction 215 (e.g., axial direction indicated by arrow). The chamber 214 extends through the barrel 212 in the axial direction 215 between an upstream side 215U and a downstream side 215D. At the upstream side 215U of the barrel 212, a material supply port 216, which can include a hopper or other material supply structure, may be provided for supplying a batch mixture 210 to the extruder 200. A cartridge assembly 217 including a honeycomb extrusion die 218 comprising slots 218S is provided at the downstream side 215D for extruding the batch mixture 210 into a desired shape and macrostructure (wall thickness Tk, cell density CD, and cell shape(s)) as the green honeycomb body 100G. The honeycomb extrusion die 218 can be preceded by other structures, such as a generally open cavity, screen 220, homogenizer 222, and the like to facilitate the formation of a steady plug-type flow front before the plasticized batch mixture 210 reaches the honeycomb extrusion die 218.

As further shown in FIG. 2, a pair of extruder screws 224 can be rotatably mounted in the barrel 212. The extruder screws 224 may be arranged generally parallel to each other, as shown, though they may optionally be arranged at various angles to each other. The extruder screws 224 may also be coupled to a driving mechanism(s) 220 located outside of the barrel 212 for rotation of the extruder screws 224 in the same or different directions. It is to be understood that both the extruder screws 224 may be coupled to a single driving mechanism 220, as shown, or to individual driving mechanisms (not shown). The extruder screws 224 operate to move the batch mixture 210 through the chamber 214 with pumping and further mixing action in the axial direction 215. Further supporting structure may be provided to support the screws 224 at their ends and/or along their length. Such supporting structure may include perforations or holes therein to allow the batch mixture 210 to flow there through.

FIG. 2 additionally illustrates the extruder 200 with the green honeycomb body 100G being extruded through slots 218S formed in the honeycomb extrusion die 218. As will be apparent from the disclosure herein, the extrusion of the batch mixture 210 through the slots 218S of the extrusion die 218 does not substantially align the spherical alumina particles contained in the batch mixture 210. The extruder cartridge 217 can include extrusion hardware such as the honeycomb extrusion die 218 and optionally a skin forming mask 226. The green honeycomb body 100G is extruded from the extruder 200, and in some embodiments the skin 106 surrounding the plurality of walls 102 is also formed during extrusion along with the plurality of walls 102 forming the matrix 101. The honeycomb body 100G is then cut to length with a cutting element 228, and provided on a tray 230. The tray 230 can be as described in U.S. Pat. Nos. 9,440,373, 9,085,089, and 8,407,915, for example. Other suitable tray designs can be used.

Cutting can be achieved by any suitable cutting method, such as wire cutting, saw blade cutting, such as with a band saw or reciprocating saw, or other cutting method. The tray 232 can be provided to a suitable dryer apparatus and dried, such as described in U.S. Pat. Nos. 9,335,093, 9,038,284, 7,596,885, and 6,259,078, for example. Any suitable drying apparatus or method can be used, such as RF drying, microwave drying, oven drying, or combinations thereof. In some embodiments, the extrudate extruded from the slots 218S of the extrusion die 218 can be provided as a log on the tray 230 and the green honeycomb body 100G can be cut from a log after drying the log. Thus, in this instance, multiple green honeycomb bodies 100G can be provided from each log.

After drying, the green honeycomb body 100G can be fired under conditions effective to convert the green honeycomb body 100G into a ceramic honeycomb body 100 comprising the aluminum titanate-cordierite composite mixture described herein. The firing can be carried out in any suitable kiln or furnace, including a tunnel kiln. The firing can be carried out at suitable ramp rates to enable a crack-free fired bodies and at suitable top firing temperatures (top soak temperatures) and soak times sufficient to convert the green honeycomb body 100 into the ceramic honeycomb body 100 comprising the aluminum titanate-cordierite mixture and that comprises the desired macrostructure, microstructure, and thermo-mechanical properties described herein.

### Batch Mixture

The batch mixture 210 utilized to manufacture the above-described ceramic honeycomb bodies 100, 100P comprising the aluminum titanate-cordierite ceramic material can comprise inorganic ingredients, organic ingredients, and a liquid vehicle. In, particular, the batch mixture 210 can comprise inorganic particulate source(s) comprising sources(s) of substantially spherical alumina, source(s) of titania, source(s) of magnesia, source(s) of silica, and possibly source(s) of an inorganic sintering aid.

The organic ingredients can comprise processing aids can include a plasticizer, lubricant, organic binder, one or more pore formers (e.g., a pore former combination of a starch and/or graphite), which can be mixed and mulled with the liquid vehicle and inorganic ingredients to form the plasticized ceramic precursor batch mixture 210. The respective inorganic particulate sources and the one or more pore formers may further exhibit the median particle diameters dₚ₅₀ as are described in Table 2 below, for example. All median particle diameters are measured by a laser diffraction technique and a Microtrac particle size analyzer.

TABLE 2
Example Raw Batch Materials and
Particle Sizes for Batch Mixtures

| Batch Component | dₚ₅₀ (μm) |
|---|---|
| Reactive Alumina Spheres 1 | 23.2 |
| Reactive Alumina Spheres 2 | 30.3 |
| Spray Dried Alumina Spheres | 30-50 |
| TiO₂ | 0.3 |
| Alumina powder | 3.0 |
| Aluminum hydrate, Al(OH)₃ | 3.5 |
| Dispersible aluminum hydrate, AlOOH | 0.1 |
| SiO₂ (Microsil) | 50 |
| Talc | 14 |
| CeO₂ (milled) | 2.5 |
| Starch (Crosslinked Pea) | 30 |
| Graphite | 37 |

Table 3 below expresses some example batch mixtures containing substantially spherical alumina in accordance with several embodiments of the disclosure that can be utilized to manufacture the above-described ceramic honeycomb bodies 100, 100P comprising the aluminum titanate-cordierite ceramic material.

TABLE 3
Batch Mixture Examples

| | Ex. ‘A’ | Ex. ‘B’ | Ex. ‘C’ | Ex. ‘D’ |
|---|---|---|---|---|
| Batch Component | (wt. %) | (wt. %) | (wt. %) | (wt. %) |
| Reactive Alumina Spheres 1 | 41.72 | *** | *** | *** |
| Reactive Alumina Spheres 2 | *** | 41.72 | *** | *** |
| Spray Dried Alumina Spheres | *** | *** | 43.46 | 43.46 |
| TiO₂ | 33.09 | 33.09 | 33.09 | 33.09 |
| SiO₂ | 3.01 | 3.01 | 1.23 | 1.23 |
| Talc | 20.74 | 20.74 | 20.74 | 20.74 |
| Ceria | 1.46 | 1.46 | 1.46 | 1.46 |
| Total Wt. % | 100.0 | 100.0 | 100.0 | 100.0 |
| Starch (SA) | 20 | 20 | 20 | 20 |
| Graphite (SA) | 10 | 10 | 10 | 10 |
| Methylcellulose A (SAP) | 3.0 | 3.0 | 3.0 | 3.0 |
| Methylcellulose B (SAP) | 1.5 | 1.5 | 1.5 | 1.5 |
| Total Methylcellulose (SAP) | 4.5 | 4.5 | 4.5 | 4.5 |
| Processing Aid (SA) | 1.0 | 1.0 | 1.0 | 1.0 |

The respective oxide weight percentages of the above batch mixtures 210 are shown in Table 4 below. The oxide weight percentages of the example honeycomb bodies 100, 100P comprising the aluminum titanate-cordierite ceramic mixture produced from the batch mixtures 210 are substantially the same as for the batch mixtures 210, but reflect the impurities therein.

TABLE 4
Batch Mixture Oxide Weight Percentages

| | Ex. ‘A’ | Ex. ‘B’ | Ex. ‘C’ | Ex. ‘D’ |
|---|---|---|---|---|
| Ceramic | (wt. %) | (wt. %) | (wt. %) | (wt. %) |
| Alumina 1 | 43.11 | *** | *** | *** |
| Reactive | *** | 43.11 | *** | *** |
| Alumina Spheres | | | | |
| 2 | | | | |
| Spray Dried | *** | *** | 43.46 | 43.46 |
| Alumina Spheres | | | | |
| TiO₂ | 33.00 | 33.00 | 32.99 | 32.99 |
| SiO₂ | 15.24 | 15.24 | 13.43 | 13.43 |
| MgO | 6.50 | 6.50 | 6.50 | 6.50 |
| Ceria | 1.46 | 1.46 | 1.46 | 1.46 |
| Impurities | 0.68 | 0.68 | 1.15 | 1.15 |
| (oxides of Fe, | | | | |
| Cr, Ca, Na, K) | | | | |

### Alumina Source

The alumina source can, for example and without limitation, be any suitable component able to provide an oxide of aluminum provided in a substantially spherical particle shape that is useful in forming the aluminum titanate-cordierite mixture described herein, and that provides a template for non-oriented grain growth that can provide AT tang/axial I ratio of less than or equal to 1.35. By “spherical,” what is meant herein is that the aspect ratio (AR) of the alumina particles comprising the alumina source, on average, is approximately 1.0, such as having a maximum diameter divided by a minimum diameter of less than or equal to 1.2, that is an AR≤1.2.

Suitable alumina particles that can be used in the batch mixture 210 and provided in spherical shape can include, but are not limited to: ball-milled alumina particles, jet-milled alumina particles, ground alumina particles, solution grown alumina particles, precipitated alumina particles, spray-dried alumina particles, and alumina particles formed via fusion technology. Further narrowing of the particle size and particle size distribution may involve sieving and/or other particle separation techniques.

In some embodiments, the alumina source has a very high purity and specifically have an impurity level such that the alumina particles used as the alumina source include less than 3.0 wt. % SiO₂, or even less than or equal to 2.5 wt. % SiO₂, or even less than or equal to 2.0 wt. % SiO₂, or even less than or equal to 1.5 wt. % SiO₂, or even less than or equal to 1.0 wt. % SiO₂ in in some embodiments. Such low silica content in the spherical alumina particles can be made by high-level fusion technology and highly-accurate separation technology. Such low silica levels in the spherical alumina particles can provide advantages of preserving the sphere shape during honeycomb sintering. High silica levels would lead to glass formation and loss of the spherical structure and additionally loss of the honeycomb's bulk porosity, % P.

The alumina source can be mixed with other inorganic oxides described herein having relatively low impurity levels. In some embodiments, the impurity level of each of the non-alumina inorganic components (e.g., titania source, magnesia source, silica source, and sintering aid) comprises less than 2.0 wt. % impurities. The alumina source can be greater than 98.0 wt. % Al₂O₃, greater than 97.5 wt. % Al₂O₃, greater than 98.5 wt. % Al₂O₃, greater than 99.0 wt. % Al₂O₃, or even greater than 99.5 wt. % Al₂O₃, in some embodiments.

In some embodiments, the median particle diameter (dₚ₅₀) of the spherical alumina source is less than or equal to 60 μm. In further embodiments, the median particle diameter (dₚ₅₀) of the spherical alumina source is greater than or equal to 18 μm. In some embodiments, the median particle diameter (dₚ₅₀) of the spherical alumina source ranges from 18 μm to 60 μm, or even in a range from 18 μm to 40 μm.

In some embodiments, the spherical alumina source comprises spherical particles having narrow particle d-factor (d_{pf}) wherein d_{pf}≤0.5, d_{pf}≤0.4, or even d_{pf}≤0.3, wherein dpf is defined as d_{pf}=(dₚ₅₀−dₚ₁₀/dₚ₅₀). Moreover, the spherical alumina source can comprise spherical particles having a narrow overall particle size distribution breadth (d_{pb}) wherein d_{bp}≤1.0, d_{bp}≤0.9, or even d_{bp}≤0.8, wherein dpb is defined as d_{bp}=(dₚ₉₀−dₚ₁₀/dₚ₅₀). Having narrow particle size distribution in the alumina spherical particles may advantageously provide formation of a narrow pore size distribution in the microstructure of the walls 104 of the fired AT-cordierite containing honeycomb body 100. Some example alumina spherical particles can include dₚ₁₀, dₚ₅₀, and dₚ₉₀ and shown in Table 5 below.

TABLE 5
Particle size data for example spherical alumina particles

| Sample | Dₚ₁₀ | Dₚ₅₀ | Dₚ₉₀ |
|---|---|---|---|
| Spherical Particle 1 | 16.25 | 23.22 | 36.19 |
| Spherical Particle 2 | 22.31 | 30.28 | 44.35 |

The spherical alumina source can comprise between 40 wt. % and 44 wt. %, or even between 42 wt. % and 44.0 wt. %, based on 100% of the total weight of the inorganics present in the batch mixture 210. In some embodiments, the spherical alumina is spray dried and pre-reacted (calcined) to form substantially pure alumina. In some embodiments described herein the spray-dried spherical alumina particles is substantially pure, meaning comprising less than 3.0 wt. % of silica in their particle mixture, less than 2.5 wt. % of silica, less than 2.0 wt. % of silica, or even less than 1.0 wt. % of silica, in their particle mixture.

### Spray Dried Alumina Spherical Particles

Low cost spherical alumina particles can be made by spray drying very low cost alumina raw materials (with dₚ₉₀<20 μm) into spherical particles of median size, preferably in the range of 18 μm to 60 μm, or even 20 μm to 40 μm in some embodiments. A low level of inorganics and organics are added to allow stabilization of the spherical alumina particles in a short heat treatment so that the alumina sphere can survive shear during mixing and extrusion through the slots 218S.

Processing ceramic honeycomb bodies 100 from spray dried, pre-reacted spherical alumina involves spray drying and pre-reacting spray dried spherical green particles. Pre-reaction can take place in a rotary calciner, for example. Use of spray dried and pre-reacted alumina particles can beneficially provide shorter ceramic honeycomb body firing cycle, higher batch yield as result of better batch homogeneity, improved reproducibility, and lower batch cost. As a result, utilizing spherical spray-dried alumina particles may be able to produce a lower cost product than the traditional process.

If spray-dried alumina spheres are used in the batch mixture, a process as shown and described with reference to FIG. 1D can be used. FIG. 1D illustrates a process flow for manufacturing a honeycomb body 100 comprising an aluminum titanate-cordierite material with lower anisotropy from a batch mixture comprising spray-dried, stabilized alumina spheres. The process flow includes, in step 120, forming alumina spheres by spray drying fine inorganic raw materials into green spherical alumina particles, and heat treating (e.g., calcining) the green alumina spheres in step 122 for stabilization thereof. Heat treatment can be at a temperature of from 1250° C. to 1,550° C., or even 1350° C. to 1,410° C., for example. The heat treated alumina spheres are then used to form a batch mixture in step 124 having the mixture described herein. In particular, the spherical alumina particles are mixed and mulled together with the other inorganic batch particulate materials (e.g., TiO₂ source, SiO₂ source, MgO source, and optional sintering aid, such as CeO₂, one or more pore formers, organic binder(s), other processing aids, and the liquid vehicle (e.g., water) to form a plasticized batch mixture having a paste-like consistency. The plasticized batch mixture is then, in step 126, extruded through slots (e.g., slots 218S) of a honeycomb extrusion die (e.g., 218). That green honeycomb body 100G is then cut to a desired length and dried as described herein. In some embodiments, as log is cut and dried and then the green honeycomb body 100G is cut therefrom. The green honeycomb body 100G is then fired at high temperature in step 128 to form a honeycomb body 100 comprising the AT-cordierite material that demonstrates less anisotropy in thermal expansion and possibly other properties than AT-based ceramic materials made from traditional platy alumina raw material.

To produce the spray-dried alumina spheroids, an aqueous slurry of fine inorganic raw materials with inorganic binders and dispersants at solid loadings between 30 wt. % and 45 wt. % is spray dried into green spherical alumina particles.

The green spray-dried alumina particles can have a median particle diameter dₚ₅₀ greater than or equal to 15 μm, greater than or equal to 20 μm, or even greater than or 25 μm in some embodiments. The green spray-dried alumina particles can have a median particle diameter dₚ₅₀ of from 20 μm and 50 μm, or even between 20 μm and 40 μm in some embodiments. The green spray-dried alumina particles can have a median particle diameter dₚ₅₀ of less than 65 μm, and a narrow overall particle size distribution (d_{pb}=dₚ₉₀−dₚ₁₀)/dₚ₅₀) wherein d_{pb}≤1.3, d_{pb}≤1.2, and d_{pb} is about 1.1 in some embodiments.

A turbomixer can be used for the preparation of the slurry for spray drying, for example a high power rotostator mixer that operates to minimize agglomerates and provides a suitable substantially homogeneous mixture. Fine alumina raw materials can be slowly added to water under mixing using a high power turbomixer, for example. The alumina raw materials for making the slurry to be spray dried can be commercial fine alumina with median particle size of less than 1 μm, commercial alumina powder with median particle size of from 2 μm to 3 μm, commercial alumina with median particle size of from 3 μm to 7 μm, or even commercial alumina with median particle size of from 5 μm to 10 μm, in some embodiments, for example. Organic packages of binder and dispersant and optional surfactant, and antifoaming agents were added. A typical organic package was 2% Styrene Acrylic Copolymer, such as Duramax B-1022, and 0.5% Ammonium Salt of Acrylic Polymer, such as Duramax D-3005.

At small and intermediate scale, a spray dryer can be used with 2 fluid fountain, parallel flow fluid nozzle, or rotary atomizer and about 1 kg/h to 20 kg/h throughput. 2-point collection can be used to achieve large particle sizes with a NPSD and with a minimized tail of fine spherical alumina particles. Spherical alumina particles can be produced with different targeted mean particle size, such as with median particle diameters between 15 μm and 65 μm.

The spray dried spherical alumina particles can be fired either in electrically or gas heated batch trays or in a rotary calcining apparatus (either batch type or continuous) with alumina or SiC tubing or on trays in batch kilns. Firing cycles depend on the exact alumina mixture and bead size. Firing temperature and time have to be high enough to initiate substantial sintering in the spray dried alumina particle so that sufficient mechanical strength is reached such that the particle survives the shear during extrusion and mixing in an extruder. Fired spray dried alumina powders can be screened before use as batch raw material. Typical screen sizes can be 150 or 270 mesh in order to remove the larger particles and further narrow the particle size distribution, and to also screen out dirt and agglomerates.

The use of spray dried and heat-treated alumina spheres in the batch mixture can offer a cost advantage compared to reactive AT-containing batches, since the additional cost for spray drying and heat treatment can be compensated by a cost reduction of the alumina raw material. In the prior art, large-size fraction milled, platy alumina is used, which is fairly expensive due to the processes used to select the desired size fraction. In the spray drying process, low cost alumina can be spray dried to desired median particle diameter (dₚ₅₀) with very narrow particle size distribution, for example.

### Magnesia Source

The magnesia source can, for example and without limitation, be any suitable compound able to provide an oxide of magnesium useful in forming the aluminum-titanate-cordierite mixture described herein. For example, the magnesia source can be selected as talc (Mg₃Si₄O₁₀(OH)₂), or talc in combination with other magnesia sources. For example, the talc source can be calcined or un-calcined talc. Optionally, the magnesia source can be one or more of MgO, Mg(OH)₂, MgCO₃, MgAl₂O₄, Mg₂SiO₄, MgSiO₃, MgTiO₃, Mg₂TiO₄, MgTi₂O₅. In other embodiments, the magnesia source can be selected from one or more of forsterite, olivine, chlorite, or serpentine. The magnesia source, when a talc, can have a median particle diameter (dₚ₅₀) that does not exceed 35 μm, or even that does not exceed 30 μm, and that can be in a range of from 6 μm to 35 μm, or even in a range of from 6 μm to 25 μm, for example. The magnesia source can comprise, on an oxide basis, from 6 wt. % to 10 wt. % MgO, or even between 6 wt. % and 8 wt. % MgO, based on 100% of the total weight of the inorganics present in the batch mixture 210. When talc is used as the magnesia source, it also comprises a silica source. When the magnesia source and the silica source comprises talc, the talc can be provided in a weight percentage of from 20 wt. % to 22 wt. %, based on 100% of the weight of the inorganics in the batch mixture 210. The median particle diameters dₚ₅₀ described throughout herein are measured by a laser diffraction technique, such as by a Microtrac particle size analyzer.

### Silica Source

The silica source can, for example and without limitation, be any suitable compound able to provide an oxide of silica useful in forming the aluminum-titanate-cordierite composite mixture described herein. The silica source can, for example, be selected from a silica source such as a SiO₂ powder such as quartz, cryptocrystalline quartz, fused silica, diatomaceous silica, low-alkali zeolite, colloidal silica, or combinations of any of the aforementioned. In embodiments, the median particle size (dp₅₀) of the silica source can be greater than or equal to 0.1 μm, and can range from about 0.1 μm to about 10 μm, in some embodiments. The silica source can comprise, on an oxide basis, from 13 wt. % and 18 wt. %, based on 100% of the total weight of the inorganics present in the batch mixture 210.

### Titania Source

The titania source can, for example and without limitation, be any suitable compound able to provide an oxide of titanium useful in forming the aluminum-titanate cordierite mixture described herein. The titania source can be provided as TiO₂ powder. Other titania sources can include Al₂TiO₅ or magnesium titanate. Titania powders having the median particle size (dₚ₅₀) shown in Table 1 can be used. For example, the titania source can have a median particle diameter of from 0.25 μm to 0.45 μm. The titania source can comprise, on an oxide basis, of from 32 wt. % to 34 wt. %, based on 100% of the total weight of the inorganics present in the batch mixture 210.

### Metal Oxide Sintering Aid

The sintering aid can, for example and without limitation, be any suitable metal oxide optionally added to the batch mixture 210 to be able to provide an enhanced sintering effect, such as to provide for an expanded/enlarged firing temperature window and/or lowered peak soak temperature useful in forming the aluminum-titanate-cordierite mixture described herein. The sintering aid can be provided in an amount of from 0.0 to 5.0 wt. %, from 0.5 wt. % and 5.0 wt. %, from 0.5 wt. % and 4.0 wt. %, or even from 1.0 wt. % to 2.0 wt. % in some embodiments, all based on the total weight of the total inorganic particles in the batch mixture 210.

In some embodiments, the sintering aid can be a metal oxide and can include, for example, one or more a metal oxides such as CeO₂, Y₂O₃, La₂O₃, CaO, or combinations thereof, provided in an amount of from 0.0 to 5.0 wt. %, for example. In one embodiment, ceria (CeO₂) is used alone, such as in an amount of from 1.0 wt. % to 2.0 wt. %, or even from 1.25 wt. % to 1.75 wt. %, based on the total weight of the inorganic particles in the batch mixture 210.

In other embodiments, yttrium oxide (Y₂O₃) and/or lanthanum oxide (La₂O₃) have been found to be a particularly good sintering additives when added in an amount of between 0.5 wt. % and 4.0 wt. %. In some embodiments, the sintering aid can include cerium oxide in combination with yttrium oxide, cerium oxide in combination with lanthanum oxide, or cerium oxide in combination with yttrium oxide and lanthanum oxide.

### Pore Former

In order to achieve the relatively-high average bulk porosity (% P≥40%) the batch mixture 210 can contain a pore-former to aid in achieving the average bulk porosity as well as the median pore diameter and the pore size distribution of the ceramic honeycomb body 100, 100P. A pore former is a fugitive material, which evaporates or undergoes vaporization by combustion during drying and/or heating of the green honeycomb body 100G and is completely removed upon firing to obtain a desired high average bulk porosity, which can be coupled with a desired coarse MPD (d₅₀) and NPSD in the ceramic honeycomb body 100, 100P.

Any suitable pore former can be used, such as, without limitation, carbon, graphite, starch, flour (wood, shell, or nut flour), polymers such as polyethylene beads, and the like, and combinations of the aforementioned. Starches can comprise corn starch, rice starch, pea starch, sago starch, potato starch, and the like. Other suitable pore formers can be used.

When used, the particulate pore former can have a median particle diameter (dₚ₅₀) in the range of from 7 μm to 70 μm, from 10 μm to 50 μm, or from 20 μm to 40 μm. In some embodiments, combinations of graphite and starch (e.g., cross-linked pea starch) in the batch mixture 210 can aid in providing relatively-high average bulk porosity (% P≥40%) in combination with suitable microstructural properties, while also reducing cracking during firing ramp up. The pore former as described herein is provided in the batch mixture 210 in a weight percent by superaddition (wt. % SA) based upon 100% of the weight of the inorganics present in the batch mixture 210.

In some example embodiments, the pore former can be provided in the batch mixture 210 in a sufficient amount to meet a target average bulk porosity sought, such as from 5 wt. % SA to 40 wt. % SA, or even 20 wt. % SA to 40 wt. % SA, for example, to form a ceramic honeycomb body having 40≤% P≤70%, wherein wt. % SA is weight percent by superaddition (SA) based on the total weight of the inorganics in the batch mixture. In the embodiments shown in Table 3, the amount of pore former can range from 28 wt. % SA to 32 wt. % SA to provide tailored average bulk porosity of between 48% and 52%. A suitable amount of pore former can be selected in the batch mixture 210 along with appropriate sizes of inorganics and firing cycles to achieve the desired average bulk porosity (% P).

In some embodiments, the pore former can comprise a combination of starch and graphite. Embodiments can include, for example, a starch:graphite ratio of between 1.5:1 and 2.5:1. For example, in the embodiments shown in Table 3, combinations of starch of from 18 wt. % SA to about 22 wt. % SA and graphite of from 8 wt. % SA to 12 wt. % SA can be used in the batch mixture 210. Such combinations of starch and graphite can provide excellent combinations of high average bulk porosity (% P) and relatively high median pore size (d₅₀) useful for filtration applications, while providing reduced cracking during initial firing ramp phase. In some embodiments, the starch pore former can comprise a crosslinked starch, such as a very highly crosslinked starch.

The weight of the pore former (wpf) in the batch mixture 210 is computed as the wpf=wi×wt. % SA/100, wherein wi is the total weight of inorganic raw materials batch mixture 210. The starch can have a median particle diameter (dₚ₅₀) in the range from about 7 μm to 50 μm, or from about 10 μm to 45 μm, or even from 20 μm to 45 μm in other embodiments. The graphite can have a median particle diameter (dₚ₅₀) in the range from about 30 μm to 50 μm in some embodiments.

### Organic Binder

The inorganic particulate batch components, along with any optional sintering aid and/or pore former, can be intimately blended with other dry processing aids, such as an organic binder. After dry blending, a liquid vehicle and other processing liquid aids, which can help impart plastic formability and green strength to the raw materials, can be added. When forming is done by extrusion, via extrusion of the plasticized batch mixture 210 through slots 218S of an extrusion die 218, the organic binder can be a cellulose-containing material.

For example, the cellulose-containing material may be, but not limited to, methylcellulose, ethylhydroxy ethylcellulose, hydroxybutyl methylcellulose, hydroxymethylcellulose, hydroxypropyl methylcellulose, hydroxyethyl methylcellulose, hydroxybutylcellulose, hydroxyethylcellulose, hydroxypropylcellulose, sodium carboxy methylcellulose, and mixtures thereof. Methylcellulose and/or methylcellulose derivatives are especially suited as organic binders for use in the batch mixture 210, with methylcellulose and hydroxypropyl methylcellulose being excellent choices. Sources of cellulose-containing materials are METHOCEL™ cellulose products available from DOW® Chemical Co.

In some embodiments, combinations of cellulose-containing materials may comprise mixtures of such materials with different molecular weights. Alternatively, the combination of cellulose-containing materials may comprise different hydrophobic groups or different concentrations of the same hydrophobic group. Different hydrophobic groups may be, by way of non-limiting example, hydroxyethyl or hydroxypropyl. The organic binder, in some embodiments, may be a combination of a hydroxyethyl methylcellulose binder and a hydroxypropyl methylcellulose binder. Other suitable combinations of organic binders may be used.

The amount of organic binder provided in the batch mixture 210 can range from 2.0 wt. % SAP to 8.0 wt. % SAP, or even 3.0 wt. % SAP to about 5.0 wt. % SAP, wherein SAP is based on a superaddition to 100% to the total weight of the inorganics and pore formers that are present in the batch mixture 210.

### Liquid Vehicle

The liquid vehicle can vary depending on the type of material used in order to impart optimum handling properties and compatibility with the other components in the ceramic batch mixture 210. The dry raw materials are typically first mixed together in dry form and then mixed with water as the liquid vehicle. The amount of liquid vehicle (LV %), by weight, can vary from one batch to another and therefore can be determined by pre-testing the particular batch for extrudability and adjusted, as needed, to achieve a proper plasticity for extrusion and optimum handling properties.

In one or more embodiments, the liquid vehicle can be provided in the batch mixture 210 in a liquid vehicle percentage LV % as a superaddition to 100% of the weight of the inorganics and pore former present in the batch mixture 210 (wt. % SAP). The LV % in the batch mixture 210 may be added to the batch mixture 210 in an amount of about 15 wt. % SAP≤LV %≤50 wt. % SAP.

In use, the liquid vehicle provides a medium for the organic binder to dissolve in, and thus provides plasticity to the batch mixture 210 and also provides wetting of the inorganic particles including the spherical alumina therein. The liquid vehicle can be an aqueous-based liquid, such as water or water-miscible solvents. In one implementation, the liquid vehicle is water, such as deionized water, but other solvents such as alcohols (e.g., methanol, ethanol, or a mixture thereof) could be used alone or in combination with water.

### Other Processing Aids

Further processing aids, such as lubricants, surfactants, and/or plasticizers can be added to the batch mixture 210. The relative amounts of processing aids can vary depending on factors such as the nature and amounts of raw materials used, etc. Processing aids can comprise one or more of sodium stearate, stearic acid, oleic acid, linoleic acid, lauric acid, myristic acid, palmitic acid, and their derivatives, ammonium lauryl sulfate, or tall oil, for example. Further non-limiting examples of processing aids are C₈ to C₂₂ fatty acids, and/or their derivatives. Additional surfactant components that may be used with these fatty acids are C₈ to C₂₂ fatty esters, C₈ to C₂₂ fatty alcohols, and combinations of these. Non-limiting examples of oil lubricants used as processing aids include light mineral oil, corn oil, high molecular weight polybutenes, polyol esters, a blend of light mineral oil and wax emulsion, a blend of paraffin wax in corn oil, and combinations of these. Processing aids can be provided in the batch mixture 210 in an amount ranging from 0.25 wt. % SA to 2.5 wt. % SA, for example.

### Batch Processing

The inorganic powdered batch ingredients, organic powdered binder, and pore former, can be intimately dry blended until homogeneous and then further blended and mulled with a liquid vehicle and one or more processing aids to impart plastic formability and form a plasticized batch mixture 210 of a consistency suitable for extrusion through the slots 218S of the extrusion die 218. The plasticized batch mixture 210 is then provided to an extruder and shaped into a green body 100G having suitable green strength. For the extrusion method described herein, a methylcellulose, hydroxypropyl methylcellulose, and/or combinations thereof, can serve as the temporary organic binder. Liquid water can serve as the liquid vehicle, and tall oil can serve as a suitable processing aid.

In accordance with embodiments described herein, the shaping of the green body 100G from the plasticized batch mixture 210 can be by extrusion through slots 218S of an extrusion die 218. However, the honeycomb bodies 100 may be manufactured by other processes wherein the batch mixture 210 is forced through a slot-like passage, such as in uniaxial or isostatic pressing and injection molding. The resulting green body 100G can be dried, and then fired in a furnace, such as a gas or electric kiln or furnace, under heating conditions effective to convert the green body 100G into a ceramic honeycomb body 100 without cracking. After firing, the ceramic honeycomb body 100 may be plugged as further discussed herein to form a plugged ceramic honeycomb body 100P.

### Firing

In one or more embodiments, the firing conditions effective to convert the green body 100G into a ceramic honeycomb body 100 can comprise, after drying, heating the green body 100G to a maximum (top) soak temperature. The maximum (top) soak temperature can be in the range of from 1,335° C. to 1,410° C. and then holding at the maximum soak temperature for a soak (hold) time sufficient to produce the aluminum titanate-cordierite composite ceramic described herein. In some embodiments, the maximum soak temperature can even be in a tighter range of from 1,335° C. to 1,360° C. The soak time can be from 2 hours to 30 hours, or even from 4 hours to 12 hours, for example. The soak time is preceded by a suitable ramp-up heating period that has a heating rate that is sufficiently slow so as to not crack the green honeycomb body 100G. The top soak can be followed by cooling period at a cooling rate that is sufficiently slow so as not to thermally shock and crack the ceramic honeycomb body 100. To obtain a plugged honeycomb body 100P, a portion of the channels 104 of the honeycomb matrix 101 can be plugged, after firing, on one or both ends, as is discussed above. During reactive high temperature honeycomb firing, the spherical alumina templates radial, non-aligned grain growth of aluminum titanate phase with the aluminum titanate b-axis being oriented perpendicular to the template surface and that can thus provide low texturing in the extruded and fired ceramic honeycomb bodies 100, 100P with an AT tang/axial i-ratio of less than or equal to 1.35.

### Example Batch Mixtures

Example batch mixtures 210 useful in forming the ceramic honeycomb bodies 100 comprising the aluminum titanate-cordierite ceramic material described herein can comprise inorganic ingredients comprising a spherical alumina source, a silica source, and a titania source, and a magnesia source, each of which can be powdered particulate source materials, or the like. In particular, the batch mixture can comprise the spherical alumina source provided in a range of from 40 wt. % to 44 wt. %; the titania source in a range of from 32 wt. % to 34 wt. %; the magnesia source provided in a range from 6 wt. % to 10 wt. %, and the silica source a range from 13 wt. % to 18 wt. %, and an optional sintering aid, wherein the wt. % of each of the spherical alumina source, titania source, magnesia source, and the silica source are all based on 100% of a total weight of the inorganics that are present in the batch mixture 210, i.e., the respective inorganic ingredients add to 100 wt. %. Additionally, the sintering aid can be provided in an amount of from 0.5 wt. % to 5 wt. %, or even 1.0 wt. % to 2.0 wt. % in some embodiments, based on 100% of a total weight of the inorganics that are present in the batch mixture 210.

Further, the spherical alumina source is substantially pure, in that it should have less than 3.0 wt. % silica content, less than or equal to 2.5 wt. % silica content, less than or equal to 2.0 wt. % silica content, or even less than or equal to 1.0 wt. % silica content, based on a total weight of the spherical alumina source.

Table 6 below shows processing details, microstructural properties, axial and tangential CTE, and Tang/Axial CTE ratio of example ceramic honeycomb bodies 100 after firing that are manufactured from the mixture examples ‘A’ and ‘B’, utilizing the raw materials from Table 2 and the batch mixtures 210 as are described in Table 3. Three fired examples were made for each of the mixtures ‘A’ and ‘B’.

TABLE 6
Properties of 2″ ceramic honeycomb bodies 100 fired to the indicated
firing temperatures and for the firing times and illustrating the
relatively low difference between tangential CTE (Tang CTE) and axial
CTE for batch mixtures 210 including the spherical alumina source.

| | Firing | | | | Axial | | | |
|---|---|---|---|---|---|---|---|---|
| | Temp/ | | | | CTE | Tang CTE | | |
| Ex. | Time | | d₅₀ | | ×10−7/° C. | ×10−7/° C. | Tang/Axial | MOR |
| No. | (° C./hr) | % P | (μm) | d_{f} | (25-800° C.) | (25-800° C.) | CTE Ratio | (psi) |
| ‘A’-1 | 1340/22 | 52.1 | 21 | 0.16 | 5.4 | 5.9 | 1.09 | — |
| ‘A’-2 | 1355/22 | 52.1 | 24 | 0.19 | 7.3 | 9.2 | 1.26 | — |
| ‘A’-3 | 1350/10 | 52.3 | 23 | 0.19 | 7.8 | — | — | 242 |
| ‘B’-1 | 1340/22 | 52.9 | 26 | 0.19 | 4.5 | 4.3 | 0.96** | — |
| ‘B’-2 | 1355/22 | 49.1 | 28 | 0.18 | 3.6 | 4.1 | 1.14 | — |
| ‘B’-3 | 1350/10 | 50.1 | 25 | 0.20 | 7.6 | — | — | 272 |

**Within measurement error in tang i-ratio measurement, as Tangential/Axial CTE Ratio of 1.00 is the lowest the ratio can be, in theory.

As can be seen from Table 6, the Tangential/Axial CTE Ratio of the example ceramic materials can range between 1.00 and 1.26, while a traditional reactive batch mixture with platy alumina and otherwise comparable batch components yields a ratio of 1.40 or more. Thus, the anisotropy in thermal expansion (CTE) measure at 25° C.-800° C. is significantly reduced by using the described spherical alumina source contained in the batch mixture 210 as compared to a reactive batch with a comparable amount of a platy alumina source. Furthermore, relatively-high average bulk porosity (% P) and relatively coarse median pore diameter (d₅₀) can be achieved using the batch mixture 210, while also maintaining low d_{f}, wherein d_{f}=(d₅₀−d₁₀)/d₅₀, and low CTE. For example, % P≥40% can be achieved with d₅₀≥10 μm, d_{f}≤0.30, and CTE≤10.0×10⁻⁷/° C. (25° C.-800° C.) in the tangential direction.

Furthermore, the ceramic honeycomb body 100, 100G can comprise modulus of rupture (MOR) of MOR≥200 psi when measured on a ceramic honeycomb body 100, 100P having a 300/15 configuration (cpsi/Tw). In other embodiments, MOR can be MOR≥242 psi as measured on a ceramic honeycomb body 100, 100P having a 300/15 configuration.

Each of the examples in Table 6 were obtained by extruding the batch mixture in plasticized through an extrusion die 218 including slots 218S to form small examples of honeycomb green bodies 100G. The small examples had an axial length of about 152 mm (6 inch) and a nominal diameter of 50.4 mm (2 inch) in transverse cross-section, a cell density of 46.5 cells per cm² (300 cpsi), and a wall thickness Tw of 0.38 mm (15 mil). These honeycomb green bodies 100G are made from the various listed batch mixtures 210 from Table 3 above are then fired in an electric furnace at the listed firing conditions. The top firing (soak) temperature (° C.) and firing (soak) time in hours were as listed.

### Phase Assemblage

The ceramic honeycomb body 100, 100G can comprise an AT-containing ceramic material that includes a primary phase of aluminum titanate solid solution comprising the pseudobrookite structure. The primary phase of the aluminum titanate solid solution comprises greater than or equal to 50 wt. % based on a total weight of inorganics in the ceramic material. In some embodiments, the primary phase of the aluminum titanate solid solution ranges from greater than or equal to 50 wt. % to less than or equal to 80 wt. % of the material, based on the total weight of inorganics in the ceramic. In some example embodiments, the primary phase of aluminum titanate solid solution comprising the pseudobrookite structure ranges from 59 wt. % to 63 wt. % of the ceramic material, based on a total weight of inorganics in the ceramic material. Other phases that can be present in the example embodiments are shown in Table 7 below.

TABLE 7
Phase Assembly (by wt. %) of Example Embodiments

| Ex. | | | | | | Cerium | MOR |
|---|---|---|---|---|---|---|---|
| No. | AT | Cordierite | Corundum | Mullite | Rutile | Titanate | (psi) |
| ‘A’-1 | 61 | 28 | 5.4 | 2.8 | 0.9 | 1.7 | — |
| ‘A’-2 | 59 | 29 | 4.6 | 5.7 | 0.5 | 1.4 | — |
| ‘A’-3 | 61 | 27 | 7.4 | 2.9 | 0.8 | 1.3 | 242 |
| ‘B’-1 | 63 | 28 | 1.1 | 5.5 | 1.0 | 1.6 | — |
| ‘B’-2 | 59 | 30 | 5.8 | 3.5 | 0.8 | 1.4 | — |
| ‘B’-3 | 62 | 26 | 7.9 | 1.7 | 1.0 | 1.0 | 272 |

The primary phase of aluminum titanate solid solution comprising the pseudobrookite structure that contains Ti, Al, O, Si, may also contain other trace elements, such as Mg, Fe, Cr, Sr, Ca. These elements may be included in the primary aluminum titanate solid solution phase as trace ceramic phases of mullite, sapphirine, and spinel, for example. These trace ceramic phases can account for less than 5.0 wt. %, based on a total weight of inorganics in the ceramic mixture, for example.

The ceramic honeycomb body 100, 100G can further comprise a ceramic material comprising a secondary crystalline phase of cordierite. The weight percentage of the crystalline phase of cordierite can range from 20 wt. % to 35 wt. %, based on a total weight of inorganics in the ceramic material. In some embodiments, the secondary crystalline phase of cordierite can range from 26 wt. % to 30 wt. %, based on a total weight of inorganics in the ceramic material(see examples in Table 7).

In addition to the primary aluminum titanate pseudobrookite structured solid solution, and secondary phase of cordierite, the ceramic material of the honeycomb bodies 100, 100P can include other phases, such as additional crystalline or glass phases. For example, mullite (3Al₂O₃-2SiO₂) and/or titania (otherwise referred to as “rutile”) may be present in the ceramic material. Similarly, alumina or crystalline alumina (corundum), spinel, and/or a glass phase may be present.

In some embodiments, the mullite (3Al₂O₃-2SiO₂) phase can be present in from 1 wt. % to 6 wt. % based on a total weight of inorganics in the ceramic material. The rutile (TiO₂) phase can be present in less than 2 wt. % based on a total weight of inorganics in the ceramic material. Small amounts of corundum (Al₂O₃) may also be present, such as from 1 wt. % to 9 wt. % based on a total weight of inorganics in the ceramic material.

Further phases including the sintering aid can be included in the ceramic material. For example, when ceria is used as the sintering aid, the phases in the ceramic material can include cerium titanate (CeTi₂O₆) and possibly cerianite (Ce⁴⁺, Th)O₂. The fired crystalline phases and phase fractions in the ceramic material listed herein are determined X-ray diffraction and the Reitveld refinement method.

In the presently-described ceramic material, the primary aluminum titanate-containing phase is made up predominantly of an Al₂TiO₅-MgTi₂O₅ solid solution. For example, in some embodiments, the Al₂TiO₅—MgTi₂O₅ solid solution can amount up to 63 wt. % of the ceramic material.

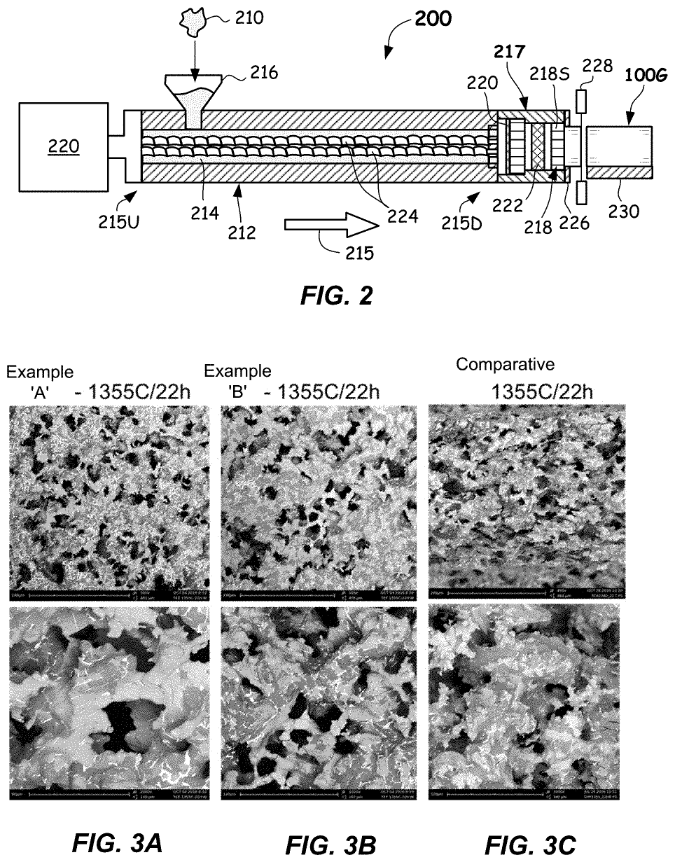

FIGS. 3A-3C illustrate scanning electron microscope (SEM) micrographs of polished ceramic bodies of examples demonstrating magnification of microstructures fired to 1355 C/22 h showing that inorganic particulates obtained from spherical alumina (Examples ‘A’, ‘B’) show similar microstructures with respect to a comparative example that does not include spherical alumina (FIG. 3C). The upper micrograph in each is at approx. 500× magnification, whereas the lover micrograph is at approximately 1000× magnification. The phase distributions with the AT phase (shown as light grey) and the cordierite phases (shown as darker grey), the porosity as black, and the lightest phase as streaks of near white is illustrate ceria-containing phases.

The phases present in the ceramic honeycomb bodies 100 were identified by X-ray diffraction (XRD). A Phillips X'Pert diffraction system equipped with a X'Celerator high speed detector was utilized. High resolution spectra were typically acquired from 15° to 100° (2θ). Rietveld refinement was used for quantification of the phase percentages.

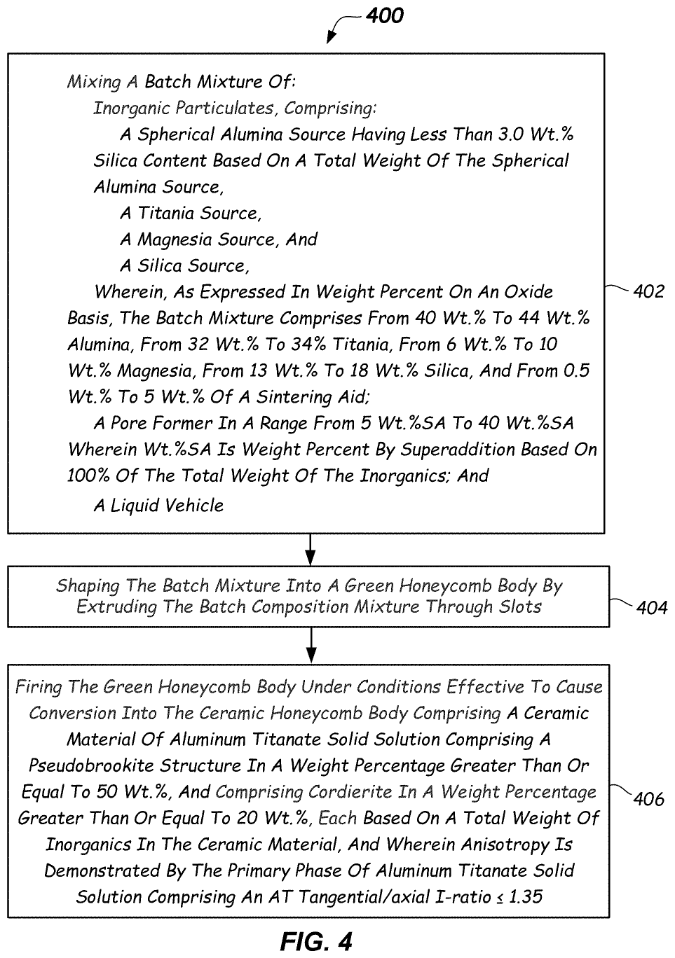

FIG. 4 illustrates a method of manufacturing a ceramic honeycomb body. The method 400 comprises, in 402, mixing a batch mixture of: inorganic particulates, comprising: a spherical alumina source having less than 3.0 wt. % silica content based on a total weight of the spherical alumina source, a titania source, a magnesia source, and a silica source, wherein, as expressed in weight percent on an oxide basis, the batch mixture comprises from 40 wt. % to 44 wt. % alumina, from 32 wt. % to 34% titania, from 6 wt. % to 10 wt. % magnesia, from 13 wt. % to 18 wt. % silica, and from 0.5 wt. % to 5 wt. % of a sintering aid; a pore former in a range from 5 wt. % SA to 40 wt. % SA wherein wt. % SA is weight percent by superaddition based on 100% of the total weight of the inorganics; and a liquid vehicle. Optionally, one or more additional processing aids, such as an organic binder, and one or more lubricants can be added to impart plastic formability and form a plasticized batch mixture 210 of a suitable past-like consistency.

In 404, the method 400 comprises shaping the batch mixture into a green honeycomb body by extruding the batch mixture through slots, such as through slots of an extrusion die. Optionally, shaping may be by any other suitable method wherein the plasticized batch mixture is flowed through slots.

The method 400 further comprises, in 406, firing the green honeycomb body under firing conditions effective to cause conversion into the ceramic honeycomb body comprising a ceramic material of a primary phase of aluminum titanate solid solution comprising a pseudobrookite structure in a weight percentage greater than or equal to 50 wt. %, and a secondary phase of cordierite in a weight percentage greater than or equal to 20 wt. %, each based on a total weight of inorganics in the ceramic material, and wherein low anisotropy is demonstrated by the primary phase of aluminum titanate solid solution by comprising an AT tangential/axial i-ratio≤1.35.

In some example embodiments, the ceramic mixture of aluminum titanate solid solution comprising a pseudobrookite structure is in a weight percentage ranging from 59 wt. % to 63 wt. %, and the cordierite is in a weight percentage ranging from 26 wt. % to 30 wt. %, each based on a total weight of inorganics in the ceramic material.

In some embodiments, the firing conditions effective to convert the green body (e.g., green body 100G) into a ceramic honeycomb body (e.g., ceramic honeycomb body 100) comprises heating the green honeycomb body 100G at a soak temperature in the range of 1335° C. to 1410° C. and maintaining the hold temperature for a soak time sufficient to convert the green honeycomb body 100G into the ceramic honeycomb body (e.g., ceramic honeycomb body 100). In some embodiments, the maximum soak temperature is in a range of from 1,335° C. to 1,360° C.

It will be apparent to those skilled in the art that various modifications and variations can be made to the various embodiments disclosed herein without departing from the scope of the disclosure. Thus, it is intended that the present disclosure cover the modifications and variations of the embodiments disclosed provided they come within the scope of the claims and their equivalents.

What is claimed is:

1. A ceramic honeycomb body, comprising:
a ceramic material comprising a primary phase of aluminum titanate solid solution comprising a pseudobrookite structure having an AT tang/axial i-ratio≤1.35, and a secondary crystalline phase of cordierite.

2. The ceramic honeycomb body of claim 1, comprising the AT tang/axial i-ratio≤1.10.

3. The ceramic honeycomb body of claim 1, comprising % P≥40%.

4. The ceramic honeycomb body of claim 1, comprising d₅₀≥10 μm, wherein d₅₀ is a median pore diameter of the ceramic honeycomb body.

5. The ceramic honeycomb body of claim 4, comprising 10 μm≤d₅₀≤30 μm.

6. The ceramic honeycomb body of claim 1 comprising d_{f}≤0.50.

7. The ceramic honeycomb body of claim 6, comprising d_{f}≤0.20.

8. The ceramic honeycomb body of claim 1 comprising CTE≤15.0×10⁻⁷/° C., wherein CTE is a coefficient of thermal expansion in at least one direction, as measured between 25° C.-800° C.

9. The ceramic honeycomb body of claim 8, comprising CTE≤4.0×10⁻⁷/° C. as measured between 25° C.-800° C. in the tangential direction.

10. The ceramic honeycomb body of claim 8, comprising 3.6×10⁻⁷/° C.≤CTE≤7.8'10⁻⁷/° C. as measured between 25° C.-800° C. in an axial direction.

11. The ceramic honeycomb body of claim 1, comprising a tang/axial CTE ratio≤1.35.

12. The ceramic honeycomb body of claim 1, comprising:
% P≥40%;
d₅₀≥10 μm, wherein d₅₀ is a median pore size;
d_{f}≤0.30; and
CTE≤10.0×10⁻⁷/° C., wherein CTE is a coefficient of thermal expansion of the ceramic honeycomb body as measured between 25° C. and 800° C. in a tangential direction.

13. The ceramic honeycomb body of claim 1, comprising:
P %≥40%;
d₅₀≥20 μm;
d_{f}≤0.20;
CTE≤10×10⁻⁷/° C. as measured from 25° C. to 800° C. in the tangential direction; and
an tang/axial CTE ratio≤1.35.

14. The ceramic honeycomb body of claim 1, wherein the secondary crystalline phase of cordierite ranges from 20 wt. % to 35 wt. %, based on a total weight of inorganics in the ceramic material.

15. The ceramic honeycomb body of claim 1, wherein the ceramic material comprises the primary phase of aluminum titanate solid solution in a weight percentage of greater than or equal to 50 wt. % and the secondary phase of cordierite in a weight percentage of greater than or equal to 20 wt. %, each based on a total weight of inorganics in the ceramic material;
wherein the ceramic honeycomb body further comprises:
40%≤% P≤70%;
10 μm≤d₅₀≤30 μm, wherein d₅₀ is a median pore diameter;
d_{f}≤0.30; and
CTE≤10.0×10⁻⁷/° C., wherein CTE is a coefficient of thermal expansion of the ceramic honeycomb body as measured between 25° C. and 800° C. in a tangential direction.

16. The ceramic honeycomb body of claim 15, further comprising:
the aluminum titanate solid solution ranging from 59 wt. % to 63 wt. %, and the secondary phase of cordierite ranging from 21 wt. % to 28 wt. %, each based on a total weight of inorganics in the ceramic material;
50%≤% P≤65%;
20 μm≤d₅₀≤30 μm, wherein d₅₀ is a median pore diameter;
d_{f}≤0.20; and
CTE≤10.0×10⁻⁷/° C., wherein CTE is a coefficient of thermal expansion of the ceramic honeycomb body as measured between 25° C. and 800° C. in a tangential direction, and
wherein low anisotropy is demonstrated by the aluminum titanate solid solution phase comprising a pseudobrookite structure by having an AT tang/axial i-ratio≤1.26.

17. A batch mixture, comprising:
a spherical alumina source having less than 3.0 wt. % silica content based on a total weight of the spherical alumina source;
a titania source;
a magnesia source;
a silica source, and
wherein, as expressed in weight percent on an oxide basis, the batch mixture comprises from 40 wt. % to 44 wt. % alumina, from 32 wt. % to 34 wt. % titania, from 6 wt. % to 10 wt. % magnesia, from 13 wt. % to 18 wt. % silica, and from 0.5 wt. % to 5 wt. % of a sintering aid.

18. The batch mixture of claim 17, wherein the silica source comprises:
spherical silica particles provided in a weight percentage of from 2 wt. % to 4 wt. %; and
talc provided in a weight percentage of from 20 wt. % to 22 wt. %,
each based on a total weight of inorganics in the batch mixture.

19. The batch mixture of claim 17, wherein the spherical alumina source comprises spherical alumina particles having 18 μm≤MPD≤60 μm, wherein MPD is median particle diameter (dₚ₅₀).

20. A method of manufacturing a ceramic honeycomb body, comprising:
mixing a batch mixture of:
inorganic particulates, comprising:
a spherical alumina source having less than 3.0 wt. % silica content based on a total weight of the spherical alumina source,
a titania source,
a magnesia source, and
a silica source,
wherein, as expressed in weight percent on an oxide basis, the batch mixture comprises from 40 wt. % to 44 wt. % alumina, from 32 wt. % to 34% titania, from 6 wt. % to 10 wt. % magnesia, from 13 wt. % to 18 wt. % silica, and from 0.5 wt. % to 5 wt. % of a sintering aid;
a pore former in a range from 5 wt. % SA to 40 wt. % SA wherein wt. % SA is weight percent by superaddition based on 100% of the total weight of the inorganic particulates; and
a liquid vehicle;
shaping the batch mixture into a green honeycomb body by extruding the batch mixture through an extrusion die comprising slots; and
firing the green honeycomb body under firing conditions effective to cause conversion into the ceramic honeycomb body comprising a ceramic material of a primary phase of aluminum titanate solid solution comprising a pseudobrookite structure in a weight percentage greater than or equal to 50 wt. %, and a secondary phase of cordierite in a weight percentage greater than or equal to 20 wt. %, each based on a total weight of inorganics in the ceramic material, and wherein low anisotropy is demonstrated by the primary phase of aluminum titanate solid solution by comprising an AT tangential/axial i-ratio≤1.35.
